(19) United States
(12) Patent Application Publication
(10) Pub. No.: US 2017/0103361 A1
(43) Pub. Date: Apr. 13, 2017

(54) SYSTEM AND METHOD FOR CHANGE REQUEST HANDLING

(71) Applicant: Ungerboeck Systems International, Inc., O' Fallon, MO (US)

(72) Inventors: Justin Ungerboeck, O'Fallon, MO (US); Krister Ungerboeck, O'Fallon, MO (US)

(73) Assignee: Ungerboeck Systems International, Inc., O' Fallon, MO (US)

(21) Appl. No.: 15/009,460

(22) Filed: Jan. 28, 2016

Related U.S. Application Data
(60) Provisional application No. 62/240,367, filed on Oct. 12, 2015.

(51) Int. Cl. G06Q 10/06; H04L 29/08

(52) U.S. Cl. CPC G06Q 10/063114; H04L 67/1097

(57) ABSTRACT

System, apparatus, and methods for creating events and handling change requests affecting the events. User devices send change requests to a server. The server identifies relevant data based on the change request and generates newsfeed items based on the relevant data and the change request. The server sends the newsfeed items to the user devices. The user devices display the newsfeed items and allow for interaction with the newsfeed items. The user devices send updates and approvals related to the change requests to the server. The server commits change requests based on the updates and approvals.

### CROSS-REFERENCE TO RELATED APPLICATIONS

This application claims priority benefit from U.S. Provisional Patent Application No. 62/240,367, filed Oct. 12, 2015.

### FIELD OF THE INVENTION

The present invention relates to systems, devices, and methods for handling change requests. More particularly, the invention relates to handling change requests for events recorded in a database.

### BACKGROUND OF THE INVENTION

The event planning industry uses a banquet event order (BEO), also referred to simply as an event order, to describe all the services, resources, and goods that are required for all the functions of an event. The BEO is typically created by the supplier that owns the venue, which provides most, if not all, of the services, resources, and goods for the event. During the course of planning an event, several change requests occur that need to be communicated to all the people involved with planning the event, including the customer paying for the event, the supplier providing the venue, and other third party suppliers that provide services, resources, or goods for the event.

Software systems that use databases to track BEOs and change requests do not have rich automated handling of change requests that allow all the people involved with planning the event to communicate the information needed to make an event successful in a timely manner.

### BRIEF DESCRIPTION OF THE DRAWINGS

The disclosed embodiments will be described with reference to the accompanying drawings.

FIG. 1 is a plan view of a room that has been set up for a function of an event in accordance with one preferred embodiment.

FIG. 2 is a diagram of devices and communications networks utilized to plan and conduct an event by ordering, delivering, and providing the services, resources, and goods utilized by the event in accordance with one preferred embodiment.

FIG. 3 is a data model of a cloud event database in accordance with one preferred embodiment.

FIG. 4 is a data model of an event in accordance with one preferred embodiment.

FIG. 5 is a data model of a supplier in accordance with one preferred embodiment.

FIG. 6 is a data model of a user in accordance with one preferred embodiment.

FIG. 7 is a data model of a newsfeed item in accordance with one preferred embodiment.

FIG. 8 is a data model of change request in accordance with one preferred embodiment.

FIG. 9 is a network messaging model that illustrates interaction between users, servers, and assistants to handle change requests in accordance with one preferred embodiment.

FIG. 10 is a network messaging model that illustrates interaction between a user and a server to handle new events and change requests using event files in accordance with one preferred embodiment.

FIGS. 11A to 11D depict a user interface of an application for viewing active alerts in accordance with one preferred embodiment.

FIGS. 12A to 12D depict a user interface of an application for editing a view in accordance with one preferred embodiment.

FIGS. 13A to 13D depict a user interface of an application for selecting quick filters of newsfeed items in accordance with one preferred embodiment.

FIGS. 14A to 14D depict a user interface of an application for viewing recipients of a newsfeed item in accordance with one preferred embodiment.

FIGS. 15A to 15D depict a user interface of an application for reassigning a task in accordance with one preferred embodiment.

FIGS. 16A to 16D depict a user interface of an application for adding rules in accordance with one preferred embodiment.

FIG. 17 depicts a user interface for adding voice, video, pictures, and text to a change request and/or an update to a change request in accordance with one preferred embodiment.

FIG. 18 is a sequence diagram that illustrates closing out a work order using annotated media in accordance with one preferred embodiment.

FIG. 19 is an illustration of a user interface displayed on a device of an event organizer that is used to select settings for a work order for an event in accordance with one preferred embodiment.

FIG. 20 is an illustration of a user interface displayed on a device of an employee of a supplier that is used to associate media with a close out of a work order for an event in accordance with one preferred embodiment.

FIG. 21 is an illustration of a user interface displayed on a device of an event coordinator that is used to create annotated media in accordance with one preferred embodiment.

FIG. 22 is an illustration of a user interface displayed on an employee device that is used to view annotated media in accordance with one preferred embodiment.

FIG. 23 is a diagram of the formation of annotated media in accordance with one preferred embodiment.

FIGS. 24A, 24B, and 24C are media timing diagrams that illustrate the insertion and mixing of annotations into original media to create annotated media.

### DETAILED DESCRIPTION

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware, entirely in software (including firmware, resident software, micro-code, etc.), or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but is not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. The propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, or any suitable combination thereof.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages.

Aspects of the present disclosure are described with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer network or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

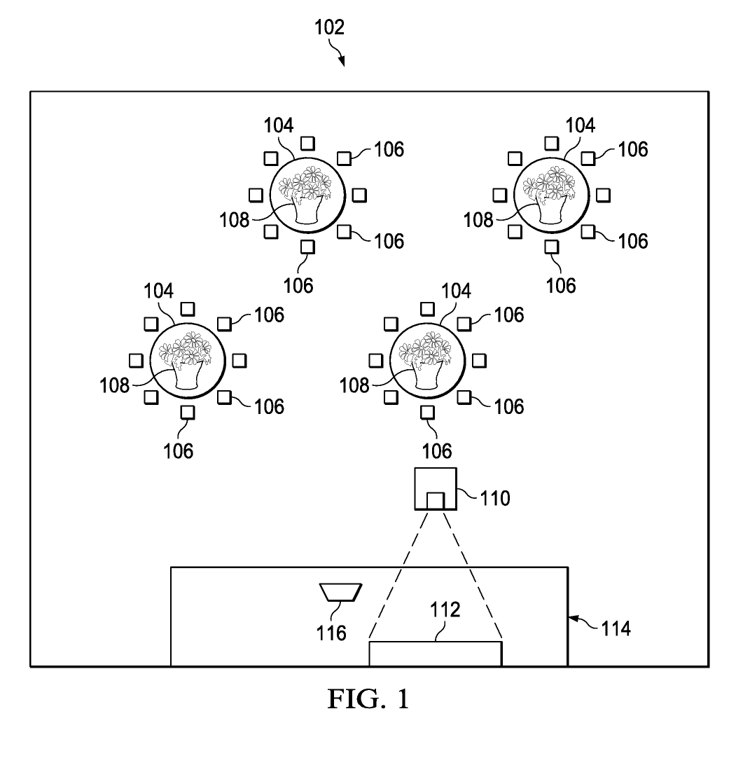

Referring to FIG. 1, is a plan view of room 102 that has been set up for a function of an event. Within room 102 are tables 104, chairs 106, flower arrangements 108, projector 110, screen 112, stage 114, and lectern 116.

Each table 104 is set with eight chairs 106 and one flower arrangement 108 at specific locations within room 102. Stage 114 is set at a focal point of room 102 with lectern 116 beside screen 112. Projector 110 is setup off of stage 114 and projects onto screen 112. In order for room 102 to be ready for the event, several services, resources, and goods must be ordered, delivered, and provided by one or more suppliers.

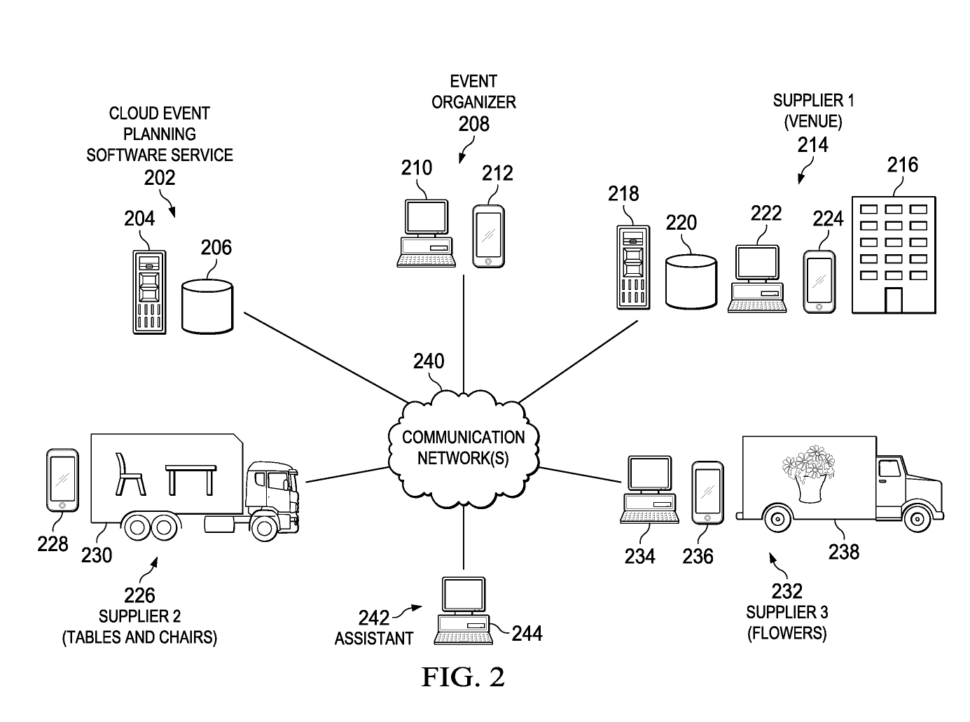

Referring to FIG. 2, is a diagram of a preferred embodiment of devices and communications networks utilized to plan and conduct an event by ordering, delivering, and providing the services, resources, and goods utilized by the event. Each server, such as cloud event server 204 and server 218, includes one or more servers that include memory and one or more processors programmed to provide and perform the processes, steps, and actions to provide and receive cloud event planning services. Each device, such as devices, 210, 212, 222, 224, 228, 234, 236, and 244, include memory and one or more processors programmed to provide and perform the processes, steps, and actions to provide and receive cloud event planning services.

Cloud event planning software service 202 utilizes cloud event server 204 and cloud event database 206 to communicate and store event data. Event data is stored on cloud event database 206 and disseminated to users of cloud event planning software service 202 via cloud event server 204. Cloud event server 204 receives event data, and from that event data, places orders to one or more suppliers, such as first supplier 214 and third supplier 232, which can be contacted via communication network 240 by cloud event server 204. Cloud event server 204 also receives change requests to change the detail of an event and the corresponding event data. Cloud event server 204 disseminates newsfeed items related to the change requests so that, in addition to updating the event data in cloud event database 206, the real world changes to the services, resources, and goods of the event will be correctly managed.

Event organizer 208 utilizes laptop computer 210 and smart phone 212 to communicate event data. Event organizer 208 can be an independent event organizer that helps individuals plan events such as weddings, an employee of a corporation that hosts events for its employees and customers, and/or an employee of a corporation that supplies one or more of the services, resources, and goods for events, such as the event planner of a hotel.

First supplier 214 supplies venue 216 for the event and utilizes server 218, database 220, computer 222, and phone 224 to communicate event data related to venue 216. First supplier 214 is the owner of venue 216 and maintains its own event planning software via server database 220 and server 218, which are set up so that database 206 of cloud event planning software service 202 is synchronized with database 220 of first supplier 214 for one or more events. Employees of first supplier 214 use one or more computers 222 and phones 224 to interact with newsfeed items and change requests related to events utilizing venue 216.

Second supplier 226 supplies tables and chairs for the event and utilizes phone 228 to communicate event data. Second supplier 226 uses van 230 to transport the tables and chairs to and from venue 216. Second supplier 226 does not maintain its own event planning software, does not utilize the services of cloud event planning software service 202, and is contactable in person or by phone 228. To receive orders and change requests for orders that specify the number of tables and chairs, the date and time of drop-off and pick-up, and the delivery location, second supplier 226 is contacted by phone 228 through a telecommunication network of communication networks 240. Instead of receiving a change request as a part of a newsfeed item from cloud event planning software service 202, second supplier 226 receives a phone call from a user of cloud event planning software service 202 in order to be notified of the changes affecting second supplier 226. The user that contacted second supplier 226 did so in response to receiving a task that was assigned by another user or an assistant of cloud event planning software service 202 or in response to a task that was automatically generated by cloud event planning software service 202.

Third supplier 232 supplies flower arrangements for the event and utilizes computer 234 and phone 236 to communicate event data. Third supplier 232 uses van 238 to transport flower arrangements to and from venue 216. Third supplier 232 does not maintain its own event planning software, does not utilize the services of cloud event planning software service 202, and is contactable in person, by computer 234, and by phone 236. To receive orders and change requests for orders that specify the type, style, color, delivery times, and delivery locations of flower arrangements, third supplier is contacted by computer 234, phone 236, and in-person. Third supplier 232 can receive emails, phone calls, and text messages generated by cloud event planning software service 202, but does not receive newsfeed items from cloud event planning software service 202.

Assistant 242 assists cloud event planning software service and all of its users by converting change requests from initial messages into database records. Assistant 242 uses computer 244 connected to cloud event server 204 via communication network 240. When assistant 242 is a virtual assistant or program, the program runs on cloud event server 204.

Communication networks 240 connect the different devices used to plan events and communicate event data. Communication networks 240 include the Internet and telecommunications networks that allow for communications via phone calls, emails, text messages, and so on.

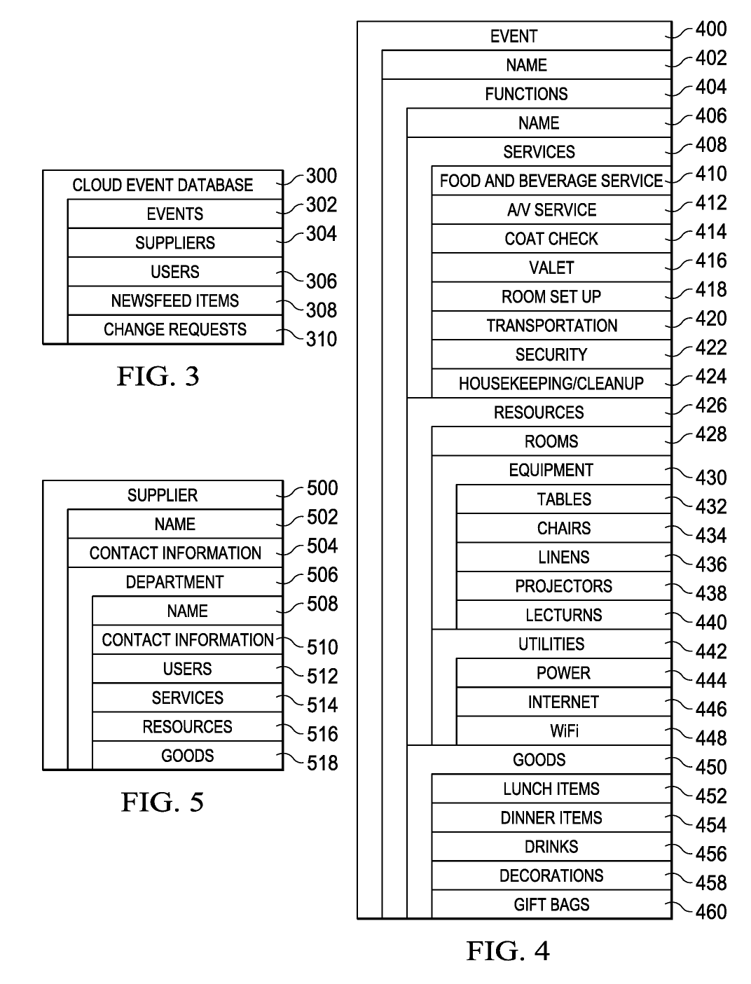

Referring to FIG. 3, is a data model of cloud event database 300. Cloud event database 300 is one embodiment of cloud event database 206, of FIG. 2, used by cloud event planning software service 202 to plan events, communicate event data, and generate orders for the services, resources, and goods provided by suppliers for an event. Cloud event database 300 includes records and event data for events 302, suppliers 304, users 306, newsfeed items 308, and change requests 310.

Events 302 represent real world events, such as meetings, conferences, and weddings, that are embodied as database records stored within cloud event database 300. Events 302 include event data to identify all the details of an event.

Suppliers 304 represent the suppliers of the services, resources, and goods for events 302 embodied as database records stored within cloud event database 300. Suppliers 304 include supplier data used to identify the supplier and to identify the services, resources, and goods provided by that supplier.

Users 306 represent users of cloud event planning software service embodied as database records stored within cloud event database 300. Users 306 include user data used to identify the user and identify the event data pertinent to that user. Event data that is pertinent to the users is communicated to users 306 with one or more newsfeed items.

Newsfeed items 308 represent information about events 302 stored within cloud event database 300 that is sent to users 306. Newsfeed items 308 include event data, supplier data, and user data related to change requests associated with events 302. Newsfeed items 308 are provided to users by a software service, such as cloud event planning software service 202.

Change requests 310 represent the changes requested by users 306 to events 302 and can be embodied as database records stored within cloud event database 300, voice messages, text messages, emails, and so on. Change requests 310 include event data, supplier data, and user data related to changes to events and provide a basis for generating newsfeed items 308.

Referring to FIG. 4, is a data model of event 400. Event 400 represents one of events 302. Event 400 has name 402, includes one or more functions 404, and represents a real world event that is created using a cloud event planning software service, such as cloud event planning software service 202.

Functions 404 of event 400 each have a name, include one or more services 408, resources 426, and goods 450, and represent discrete portions of an event. For example, an event can include a coat check function along with a cocktail reception function followed by a dinner function. Each of the coat check function, the cocktail reception function, and the dinner function have their own services, resources, and goods that are supplied for that function of the event by one or more suppliers.

Services 408 represent real world services that are provided by a supplier, such as first supplier 214, second supplier 226, or third supplier 232. Services 408 include food and beverage service 410, audio/video (a/v) service 412, coat check 414, valet 416, room set up 418, transportation 420, security 422, and housekeeping/cleanup 424. Food and beverage service 410 includes the service provided by servers and bartenders that serve food and beverage items at the event. A/v service 412 includes the service provided by the technicians that support a/v items, set up, and tear down. Coat check 414 includes the service provided by the employee responsible for checking coats in and out and the room for where the coats are stored. Valet 416 includes the service provided by the valet drivers that park cars at the venue for guests of the event. Room set up 418 includes the service of setting up rooms, equipment, and goods for the event by the employees of the suppliers. Transportation 420 includes the service of transporting guests of the event to and/or from different portions of the event. Security 422 includes the service of providing security personnel to protect and keep safe the guests of the event. Housekeeping/cleanup 424 includes the service of cleaning the rooms and locations where the event was held after the event.

Resources 426 represent real world property, items, and equipment that are used during the event and are generally returned to or reclaimed by their respective suppliers after the event. Resources 426 include rooms 428, equipment 430, and utilities 442. Rooms 428 include all the rooms and/or spaces utilized for the event, such as an outdoor pool area or an indoor ballroom. Rooms 428 can be subdivided, such as into booth areas for large conventions or trade shows. Equipment 430 includes tables 432, chairs 434, linens 436, projectors 438, lecterns 440, and so on that are provided by one or more suppliers and used during the event. Utilities 442 include power 444, internet 446, Wi-Fi 448, and so on, that are provided for the rooms and guests attending the event.

Goods 450 represent real world items that are consumed or disposed of at the event. Goods 450 include food items, such as lunch items 452 and dinner items 454, and various other items such as drinks 456, decorations 458, and gift bags 460.

Referring to FIG. 5, is a data model of supplier 500. Supplier 500 represents one of suppliers 304.

Supplier 500 represents a real world supplier of one or more services, resources, and goods that are used at an event, such as first supplier 214, second supplier 226, and third supplier 232. Supplier 500 can also represent an event organizer, such as event organizer 208. Supplier 500 has name 502 and contact information 504 that allow the system and its users to identify and contact supplier 500 directly. Supplier 500 includes one or more departments 506.

Department 506 represents a division of supplier 500 that is responsible for one or more services, resources, and goods supplied by supplier 500. Department 506 has name 508 and contact information 510, which allow the system and its users to identify and contact department 506 of supplier 500 directly. Department 506 includes one or more users 512, services 514, resources 516, and goods 518. Users 512 of department 506 of supplier 500 represent actual users of the system and are an embodiment of users 306 of cloud event database 300. Services 514, resources 516, and goods 518 represent the actual services, resources, and goods provided by supplier 500. Services 514, resources 516, and goods 518 of supplier 500 can be matched, keyed, or linked by a database to services 408, resources 426, and goods 450 of event 400.

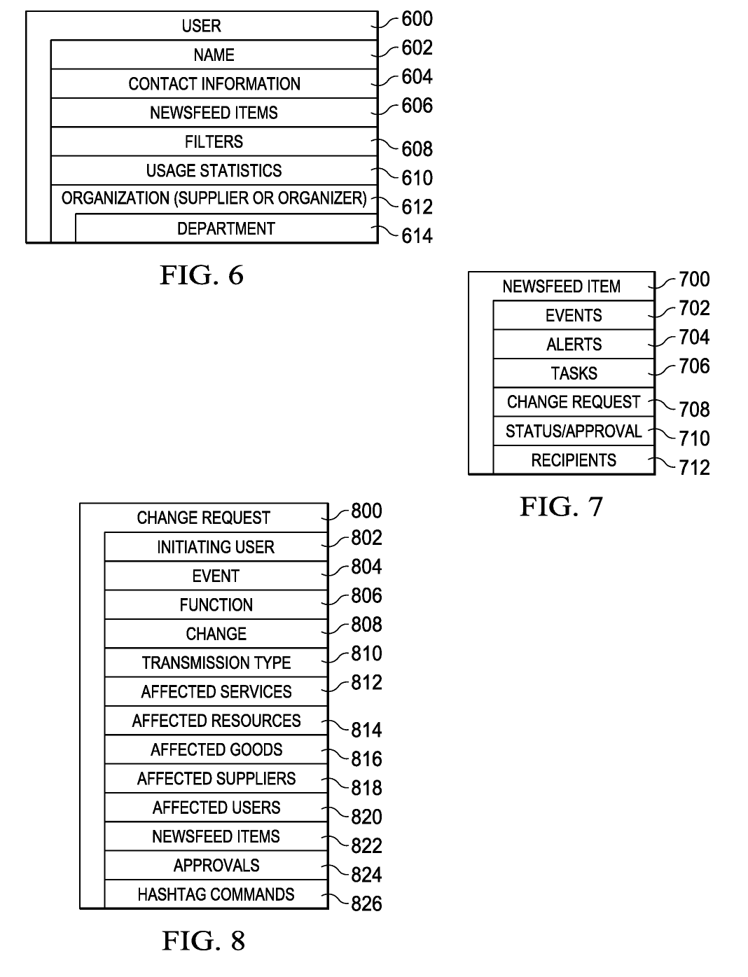

Referring to FIG. 6, is a data model of user 600. User 600 represents one of users 306.

User 600 represents a real world user that uses a cloud event planning software service and can be an employee, manager, or owner of one or more suppliers represented by suppliers 304.

User 600 includes name 602, contact information 604, newsfeed items 606, filters 608, usage statistics 610, and organization (supplier or organizer) 612 that are associated with user 600.

Name 602 and contact information 604 allow the system and its users to identify and contact user 600 directly.

Newsfeed items 606 provide information about an event and changes to the event and are associated with user 600 so that newsfeed items 606 can be disseminated to user 600.

Filters 608 associated with user 600 allow a user to specify filters for which newsfeed items will be displayed to the user. Filters 608 can be based on any data within the event database, such as data relating to events 302, suppliers 304, users 306, newsfeed items 308, and change requests 310. Different newsfeed items have different levels of importance and usefulness for user 600. Filters 608 can be set up by user 600 so that the most important and useful data shows up in a newsfeed for user 600. For example, user 600 may filter out increases to the number of guaranteed guests that are less than 20% or are less than a fixed number. User 600 may also filter out newsfeed items that do not have any alerts associated with the newsfeed item. User 600 may also filter out newsfeed items initiated by other suppliers.

Usage statistics 610 identify and include various statistics related to use of the system by user 600. Usage statistics 610 include statistics such as the average time before viewing a newsfeed item after the newsfeed item was sent, the average time to respond to newsfeed items by either reassigning the newsfeed items or by completing any tasks related to the newsfeed items, the average time to complete tasks related to newsfeed items, and the average number of alerts per newsfeed item for user 600.

Organization 612 identifies an organization that user 600 is associated with. Organization 612 is one of suppliers 304 and represents suppliers or organizers, such as first supplier 214, second supplier 226, third supplier 232, and event organizer 208.

Department 614 identifies a division of organization 612 to which user 600 is associated.

Referring to FIG. 7, is a data model of newsfeed item 700. Newsfeed item 700 represents one of newsfeed items 308 of cloud event database 300. Newsfeed item 700 includes information sent to a user of the system that is related to one or more events and change requests and is displayed on a newsfeed of a device of the user. Newsfeed item 700 includes event 702, alerts 704, tasks 706, change request 708, status/approval 710, and recipients 712.

Event 702 identifies one of events 302 to which newsfeed item 700 is associated.

Alerts 704 identify one or more alerts that range in type and severity and indicate that newsfeed item 700 needs attention from one or more users of the system. Alerts 704 are created by the system in response to changes to an event. Any detail of an event can be changed, such as the number of guaranteed guests, the color of the flowers for the decorations, the type of food being served, whether a projector needs to be provided, and so on. Additionally, slow moving changes can occur, such as increasing the number of guaranteed guests from 100 to 115, then to 130 so that even though each incremental change is less than 20%, the overall change is greater than 20%. Alerts specific to each of these situations can be created by users of the system. Alerts can also be created to identify other users who have not viewed newsfeed items and are creating a bottleneck to completing a task, which is especially important when an event is about to begin and there is little time available to resolve a change request.

Tasks 706 identify one or more tasks that need to be completed for change request 708. Tasks 706 include contacting suppliers that do not use cloud event planning software service, verifying that a change is correct, and indicating that the change will be accepted. Tasks 706 include tasks created by the cloud event planning software service. As one example, event organizer 208 submits a change request asking that the chairs supplied by second supplier 226 be changed from pink to blue, the system can create a task for contacting second supplier 226 and assign that task to an appropriate user.

Tasks 706 also include tasks created by users of the system, such as when the head of a department of a supplier receives a change request and creates multiple tasks to be completed by other employees within the department.

Change request 708 identifies one of change requests 310 to which newsfeed item 700 is associated. Newsfeed item 700 was generated in response to receipt of change request 708 by the system and each of the items within newsfeed item 700 are based on the change request 708, including event 702, alerts 704, and tasks 706.

Status/approval 710 identifies the status of newsfeed item 700. In order for status 710 of newsfeed item 700 to be fully approved and completed, all tasks 706 must be completed and approved.

Recipients 712 identify which of users 306 will receive newsfeed item 700. Recipients 712 can be affected by one or more filters, such as filters 608, to reduce the total number of recipients 712 that receive newsfeed item 700.

Referring to FIG. 8, is a data model of change request 800. Change request 800 represents one of change requests 310.

Change request 800 includes or is associated with initiating user 802, event 804, function 806, change 808, transmission type 810, affected services 812, affected resources 814, affected goods 816, affected suppliers 818, affected users 820, newsfeed items 822, and approvals 824.

Initiating user 802 identifies which user of users 306 initiated change request 800. Newsfeed item filters 608 can be based on whether a user is the initiating user of the change request or newsfeed item.

Event 804 and function 806 identify to which event and function of events 302 change request 800 is related.

Change 808 identifies the change that is being made to function 806 of event 804 that necessitates a change to the event data in the event database, such as cloud event database 300.

Transmission type 810 identifies how the change request 800 was submitted to the system and can include types for, voice messages, text messages, email, and so on. Newsfeed item filters 608 of FIG. 6 can be based on transmission type 810 so that newsfeed items transmitted as a voice message can receive a higher priority or placement in a newsfeed of a user.

Affected services 812, affected resources 814, affected goods 816, affected suppliers 818, and affected users 820 identify one or more services, resources goods, suppliers, and users related to a function of an event that will be affected by change 808 of change request 800. Affected services 812, affected resources 814, affected goods 816, affected suppliers 818, and affected users 820 are determined by cloud event planning software service based on change request 800. Affected services 812, affected resources 814, affected goods 816, affected suppliers 818, and affected users 820 can be determined by providing change request 800 to a human assistant to interpret change request 800 and identify affected services 812, affected resources 814, affected goods 816, affected suppliers 818, and affected users 820.

Newsfeed items 822 identify one or more newsfeed items 308 that are associated with change request 800. Cloud event planning software service generates newsfeed items 822 based on change request 800 and event data related to change request 800.

Approvals 824 identify one or more approvals related to change request 800. The suppliers for an event may not be able to accommodate all change requests for that event based on one or more of the timing of the event, the timing of the change request, and the nature of the request. Suppliers provide approvals, identified by approvals 824 of change request 800, to indicate that a change request will be accepted for the event related to the change request.

Hashtag commands 826 allow users to create messages that identify specific event data related to an event and/or cause cloud event planning software service to perform specific commands. When received from a user of the system, change request 800 may be in the form of a voice message, email, or text message. The system converts this initial message form of the change request into a database record that identifies event data relating to the change request, including function 806, event 804, initiating user 802, and so on. The message form of the change request may include hash tag commands 826 that associate data in the change request to event data in the system or cause the system to perform certain actions. Hash tag commands 826 can: identify a specific event, e.g., “#GalaDinner”; identify a specific user, department, or supplier, e.g., “#HotKitchen”; identify a task to be created, “#notify #HotKitchen to order organic chicken for #GalaDinner”, where the #notify command causes the system to create a newsfeed item and task for notifying the hot kitchen department of a supplier; and force an alert to be created, e.g., “#important #notify #HotKitchen to order organic chicken for #GalaDinner” where the #important command forces an alert to be created for the newsfeed items generated for the change request.

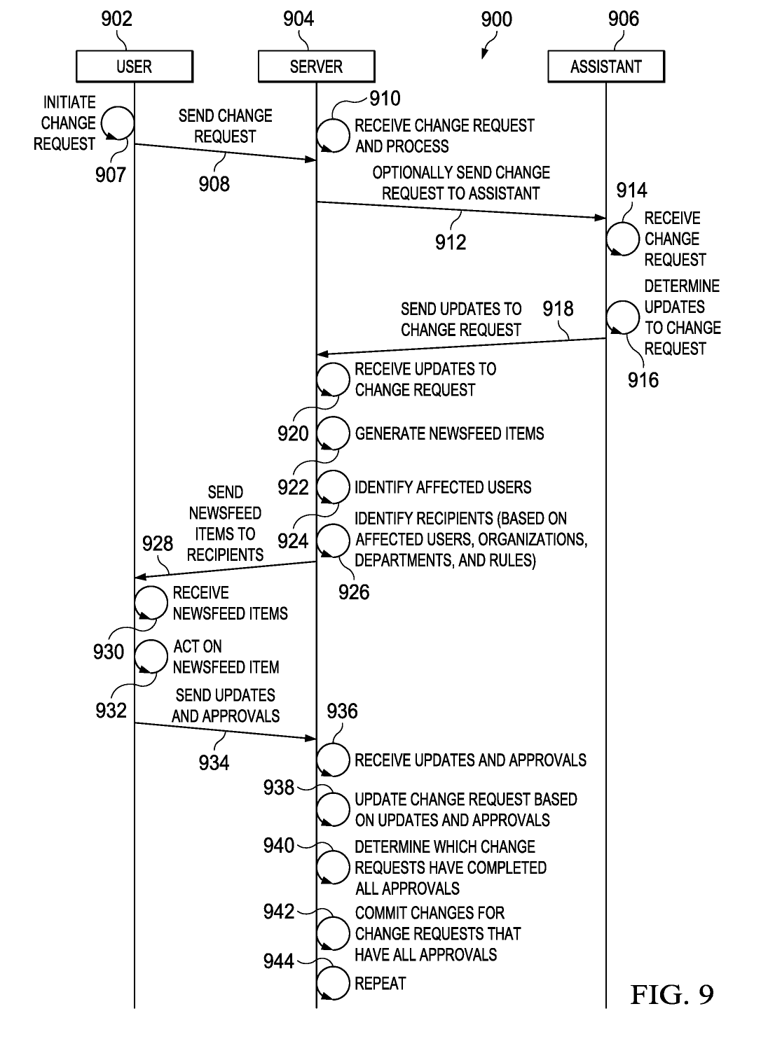

Referring to FIG. 9, diagram 900 illustrates a preferred embodiment of the interaction between users 902, server 904, and assistants 906 to handle change requests.

User 902 represents a user of the system identified by one of users 306 of cloud event database 300, where user 902 is using a device, such as a phone or computer. Server 904 represents a cloud event planning server, such as cloud event planning server 204 of cloud event planning software service 202. Assistant 906 is a real world assistant or a virtual assistant that is able to update event data based on change requests received from users via interaction with server 904.

At step 907, user 902 initiates a change request. At step 908, user 902 sends the change request to server 904. The change request can be received as one or more of a voice message, a text message, an email, an updated event file, a photo, a picture, a video, a video message, and so on. For example, a mobile phone app of cloud event planning software service used by an event organizer on phone 212 can create a special contact in an address book of the phone 212 of the event organizer. The event organizer can call the special contact and leave a voice message that the cloud event planning software service links to the event organizer and event data related to the event organizer. The special contact also includes, in a notes section, hashtags, hyperlinks, and textual data related to event data for an event.

At step 910, server 904 receives the change request and the cloud event planning software service determines event data related to the change request, such as the event and function, to identify which events, functions and users are associated with the change request, such as initiating user 802, event 804, function 806, change 808, and transmission type 810 of change request 800.

At step 912, server 904 optionally sends the change request to assistant 906. When the change request cannot be fully resolved by server 904, such as with a voice message that cannot be fully transcribed or a text message that contains too many abbreviations to be processed automatically, server 904 sends the unresolved change request to an assistant for further processing.

At step 914, assistant 906 receives the change request. Assistant 906 is utilized by the cloud event planning software service to help all suppliers using the cloud event planning software service.

At step 916, assistant 906 determines updates to the change request. Assistant 906 uses an application, such as a web browser connected to cloud event server, to finish the conversion of the original message form of the change request into a database record from of the change request, by updating event data including the number, types, and quantities of services, resources, and goods for the event related to the change request.

At step 918, assistant 906 sends the updates to the change request to server 904. At step 920, server 904 receives the updates to the change request. When assistant 906 uses a web browser connected to server 904, the changes made by assistant 906 to the event data related to an event are sent and received as assistant 906 makes changes to the event data.

At step 922, server 904 generates newsfeed items. The newsfeed items generated by server 904 are based on the change request and the updates to the change request, if any, made by assistant 906 along with event data related to the change request. The generated newsfeed items include alerts to indicate the importance of the newsfeed items and tasks that need to be performed for the change request.

At step 924, server 904 identifies users that are affected by the change request, such as users from users 306. Each event is associated with several different users of different suppliers. When a change request does not affect a certain supplier, then the users associated with that supplier will not be associated with the newsfeed item for the change request. Certain newsfeed items and tasks may be internal to a supplier, such as between the manager and employees of a department of a supplier, and these internal newsfeed items and tasks may only be shown to the users of that supplier.

At step 926, server 904 identifies recipients of the newsfeed items based on affected users, organizations, departments, and filters, and rules. Certain filters or rules may preclude some affected users from receiving a newsfeed item. For example, when the number of guaranteed guests is raised from 100 to 115 and users of the supplier of the venue have filters set to ignore changes to the number of guaranteed guests so long as the number of guaranteed guests remains below a threshold (e.g., 150 guaranteed guests), then the users of the supplier will not see a newsfeed item for the increase in the number of guaranteed guests.

At step 928, server 904 sends the newsfeed items to the users identified as recipients. For users with an application running on a smart phone, also known as a mobile phone app, the newsfeed items are sent to the application. Additionally, email, text messages, voice messages, video messages, and phone calls can be sent or placed by server 904 to users that prefer or require those forms of communication and these messages can include attachments, such as audio files, video files, text files, and so on.

At step 930, user 902 receives newsfeed items for which user 902 was identified as a recipient. For users with a mobile phone app, the newsfeed items show up in the newsfeed on the phone of the user. Additionally, email, text messages, voice messages, and phone calls are received by users that prefer or require those forms of communication.

At step 932, user 902 interacts with or acts on the newsfeed item. Users can reassign tasks, create new tasks, update status, create alerts, and perform actions based on the newsfeed item using the user interface of the application on the smart phone.

At step 934, user 902 sends updates and approvals related to the newsfeed items received by user 902. These updates and approvals can be sent directly via the cloud service application running on a device of the user or by secondary applications that can be controlled by the cloud service application, such as text messaging or email programs.

At step 936, server 904 receives the updates and approvals from user 902. The updates and approvals can be received from cloud service applications running on user devices or via text messages, voice messages, email, and so on. When text messages, voice messages, and email are used, server 904 converts these messages into database records and maps the data from the messages to the appropriate event data, supplier data, and user data within the database.

At step 938, server 904 updates change requests based on the updates and approvals received from user 902.

At step 940, server 904 determines which change requests have completed all approvals. Change requests that have completed all approvals have no more tasks to complete and signify that the change request has been accepted by the affected suppliers so that the event related to the change request will be conducted in accordance with the change request instead of being conducted as originally requested.

At step 942, server 904 commits changes related to the change requests that have received all required approvals by sending updated orders to the affected suppliers. These changes to the database are synchronized with other databases utilized by the suppliers using the cloud event planning software service.

At step 944, server 904 repeats from step 910, treating the updated change request similar to how a new change request is treated. Repeating the process allows for several iterations of tasks, changes, and updates to occur in order to complete a change request.

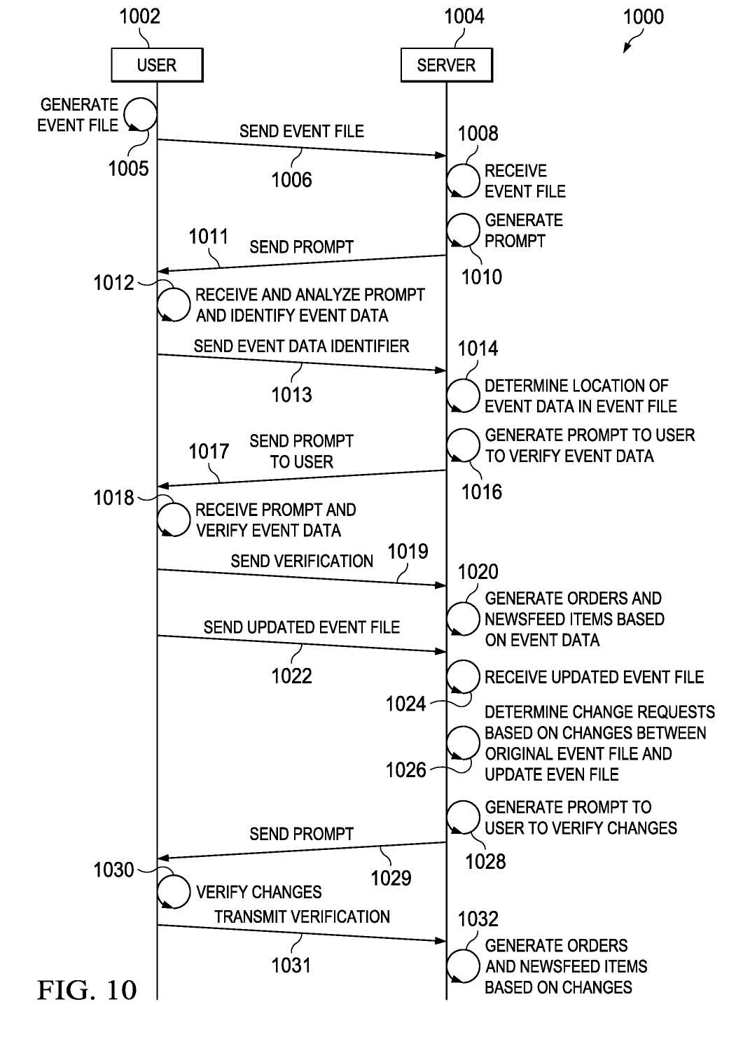

Referring to FIG. 10, diagram 1000 illustrates a preferred embodiment of the interaction between a device of user 1002, and server 1004 to handle new events and change requests using event files created by word processor or spreadsheet programs.

User 1002 is one embodiment of event organizer 208 using a device, such as a phone or computer. Server 1004 is one embodiment of cloud server 204.

At step 1005, user 1002 generates an event file. At step 1006, user 1002 sends the event file to server 1004. The event file is prepared using a computer program, such as a word processer, a spreadsheet, an email client, and so on. User 1002 can use highly detailed documents that specify every detail of an event and may use templates or copies of prior event files to generate a new event file.

At step 1008, server 1004 receives the event file from user 1002. The event file can be received as an attachment to an email, the body of an email, or uploaded to server 1004 via a client application (such as a web browser or a desktop application).

At step 1010, server 1004 generates a user prompt. At step 1011, server 1004 sends the prompt to user 1012 to identify event data within the event file. In the prompt, server 1004 indicates to user 1002, for example, through a message displayed on a screen of a computer of user 1002, the type of event data the user should identify, such as the name of the event and the number of guaranteed guests.

At step 1012, user 1002 receives the prompt and identifies the event data contained within the event file. User 1002 identifies the event data by selecting or highlighting the data in the event file.

At step 1013 the user sends an event data identifier to the server.

At step 1014, server 1004 determines the location of event data in the event file based on the identification of the event data by user 1002. When the event file is a file created with a word processing program, server 1004 finds delimiters associated with the event data to create references to where the event data is stored. When the event file is a spreadsheet, for example, server 1004 creates references using the row and column number for individual cells that contain pertinent event data identified by user 1002. After determining a reference, server 1004 scans the event file to determine if the same event data is present elsewhere in the event file.

At step 1016, server 1004 generates a prompt to user 1002 to verify event data found by server 1004 in the event file. Server 1004 indicates to user 1002 the locations and/or values of the event data within the event file so that user 1002 can verify the event data identified by server 1004.

At step 1017 the prompt is sent to user 1002.

At step 1018, user 1002 receives the prompt and verifies the event data that was found by server 1004. User 1002 can indicate the verification of each item of data individually or provide an indication that verifies that all the event data found by server 1004 is correct so that server 1004 can generate orders and newsfeed items.

At step 1019 a verification is sent to server 1004.

At step 1020, server 1004 generates orders and newsfeed items based on the event data found in the event file. The orders include orders for the services, resources, and goods needed to create the event and include room reservations, table and chair rentals, flower deliveries, and so on. After creating the event, server 1004 is ready to receive updates and changes to the event file.

At step 1022, user 1002 sends an updated event file to server 1004. The updated event file is sent, for example, via an email.

At step 1024, server 1004 receives the updated event file from user 1022. Server 1004 can utilize a special email address that receives and automatically processes the updated event file.

At step 1026, server 1004 determines one or more changes requests, such as change requests 310, based on differences between the original event file and the updated event file. The references, such as the delimiters for word processor files and row and column numbers for spreadsheets, are used to locate the updated information within the event file.

At step 1028, server 1004 generates a prompt to user 1002 to verify the change requests determined by server 1004 are accurate. Server 1004 indicates to user 1002 the event data that was changed between the prior version of the event file and the updated version of the event file.

At step 1029, the prompt is sent to the user.

At step 1030, user 1002 verifies that the change requests determined by server 1004 are accurate. User 1002 can verify each individual change request is accurate or verify that all change requests are accurate by clicking a button in a stand-alone application. At step 1031, user 1002 transmits the verification or by sending a response to an email created by server 1004 for the verification of the change requests.

At step 1032, server 1004 generates orders and newsfeed items based on the changes and disseminates the newsfeed items using an interaction similar to the interaction described in FIG. 9. The orders and newsfeeds are sent to suppliers and users by server 1004 to start the process of updating the event so that the event will take place in accordance with the changes specified in the updated event file.

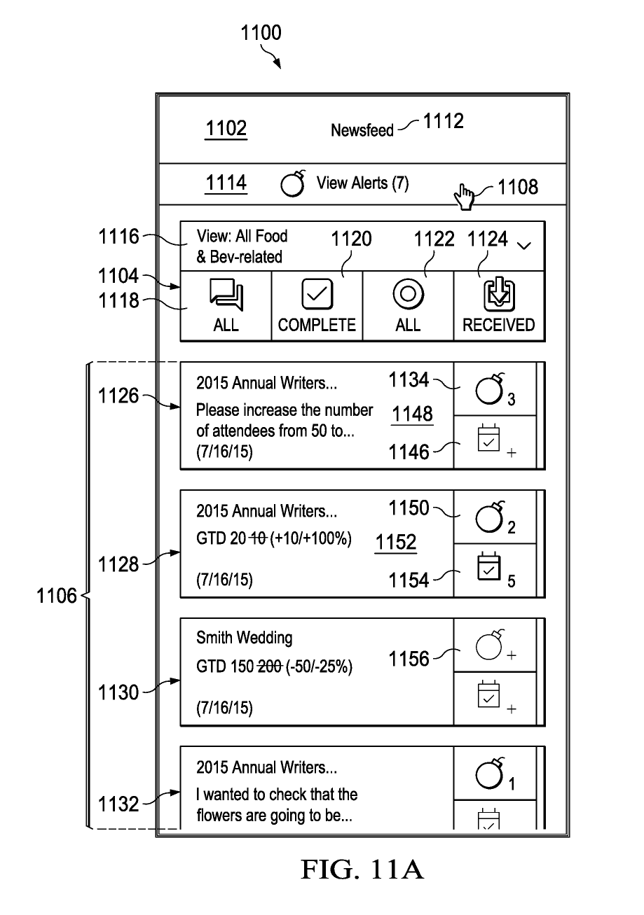

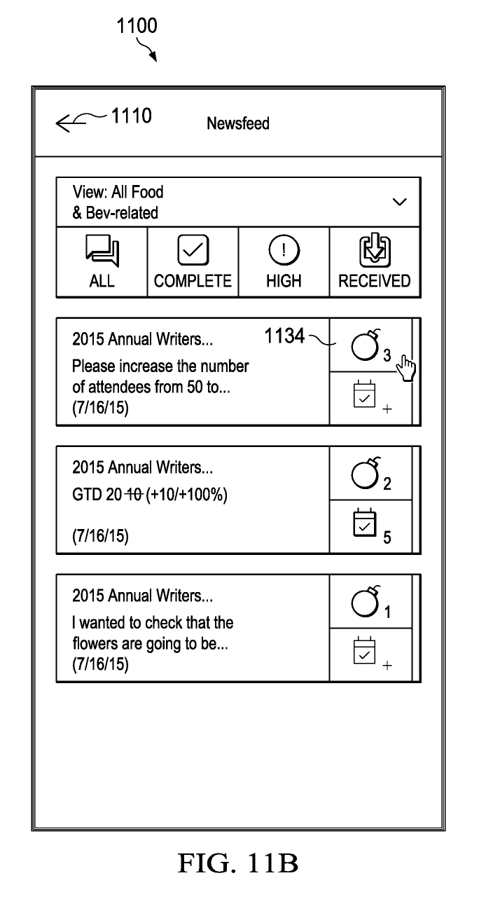

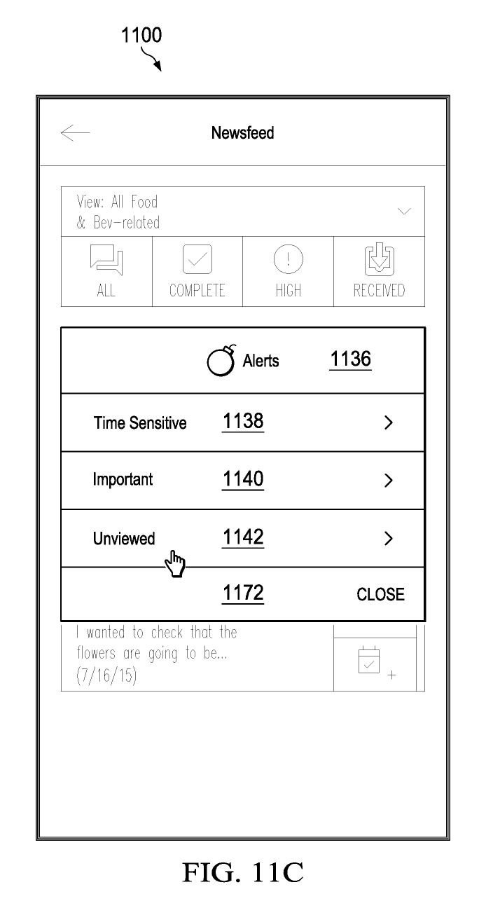

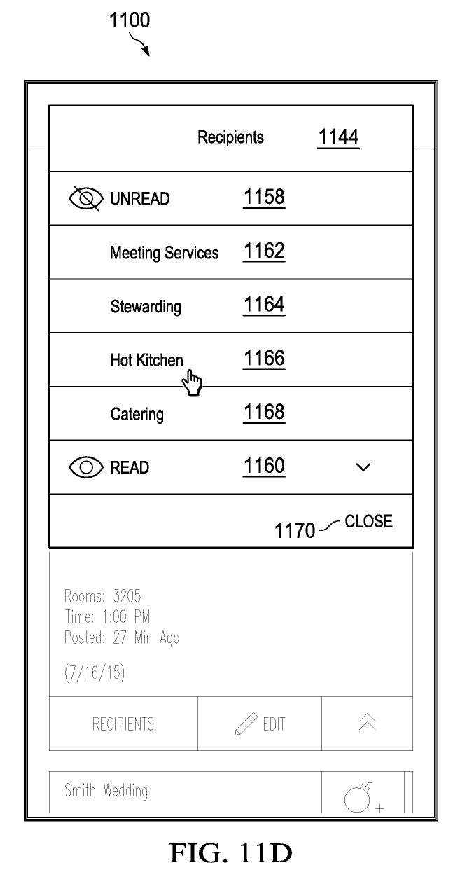

Referring to FIGS. 11A-11D, depict a user interface of an application used by one of users 306 for viewing active alerts.

Display 1100 is a display of the user interface on an application used with cloud event planning software service by a device, such as phone 212 or computer 222 of FIG. 2. Display 1100 of the user interface includes title bar 1102, view bar 1104, newsfeed 1106, and cursor 1108.

Title bar 1102 includes back button 1110 shown in FIGS. 11B and 11C title 1112 and alerts bar 1114. Back button 1110 returns to a previous screen displayed by the application and title 1112 identifies the current screen displayed by the application.

Alerts bar 1114 displays the number of newsfeed items that include an alert. In alternative embodiments, alerts bar 1114 displays the sum of the number of alerts for all newsfeed items.

View bar 1104 includes view name bar 1116 and quick filter icons 1118 to 1124.

Newsfeed 1106 includes newsfeed items 1126 to 1132 that each include several user interface elements. Newsfeed item 1126 includes alerts icon 1134, tasks icon 1146, and description 1148. Alerts icon 1134 includes an image of a “time-bomb” and a number that represents the number of alerts currently associated with newsfeed item 1126. Tasks icon 1146 includes an image of a task pad and a plus sign that indicates that no tasks are currently associated with newsfeed item 1126. Description 1148 of newsfeed item 1106 includes the name of the event, the date newsfeed item 1126 was received and information related to the change requests associated with newsfeed item 1126, such as a request to increase the number attendees.

Newsfeed item 1128 includes alerts icon 1150, description 1152, and tasks icon 1152. Tasks icon 1152 includes a number that indicates the number of tasks associated with newsfeed item 1128. Newsfeed item 1130 includes alerts icon 1156 that includes a plus sign that indicates that no alerts are currently associated with newsfeed item 1130.

When alerts bar 1114 is selected, such as by a mouse click or a touch gesture, the newsfeed items 1126 to 1132 are filtered to remove newsfeed item 1130 from newsfeed 1106 since newsfeed item 1130 did not have any alerts. When alerts icon 1134 of newsfeed item 1126 is selected, title bar 1102, view bar 1104, and newsfeed 1106 are disabled and alerts menu 1136 shown in FIG. 11C is displayed.

Alerts menu 1136 includes additional filters associated with the alerts of the currently selected newsfeed item 1126, including time sensitive filter 1138, important filter 1140, and unviewed filter 1142. Time sensitive filter 1138 filters tasks of newsfeed item 1126 to show tasks that are time sensitive. Important filter 1140 filters tasks of newsfeed item 1126 to show tasks that are important.

Alerts menu 1136 also includes close element 1172 that, when selected, closes alerts menu 1136 and returns to the prior screen, which re-enables title bar 1102, view bar 1104, and newsfeed 1106.

When unviewed filter 1142 is selected, alerts menu 1136 is replaced by recipients menu 1144 shown in FIG. 11D.

Recipients menu 1144 includes one or more filter options that filter the contents of recipients menu 1144, including unread filter option 1158 and read filter option 1160. When unread filter option 1158 is selected, recipients who have not read newsfeed item 1126 are displayed and when read filter option 1160 is selected, recipients who have read newsfeed item 1126 are displayed. Unread filter option is selected as the default filter option for recipients menu 1144 when recipients menu 1144 is displayed in response to selection of unviewed filter 1142.

Recipients menu 1144 displays the users, departments, and suppliers that are recipients associated with newsfeed item 1126, including recipients 1162 to 1168.

Recipients menu 1144 sorts the display of the recipients by whether the newsfeed item has been read or is unread and display the group of recipients who have not read newsfeed item 1126.

Recipients menu 1144 also includes close element 1170 that, when selected, closes recipients menu 1144 and returns to the prior screen, which is alerts menu 1136.

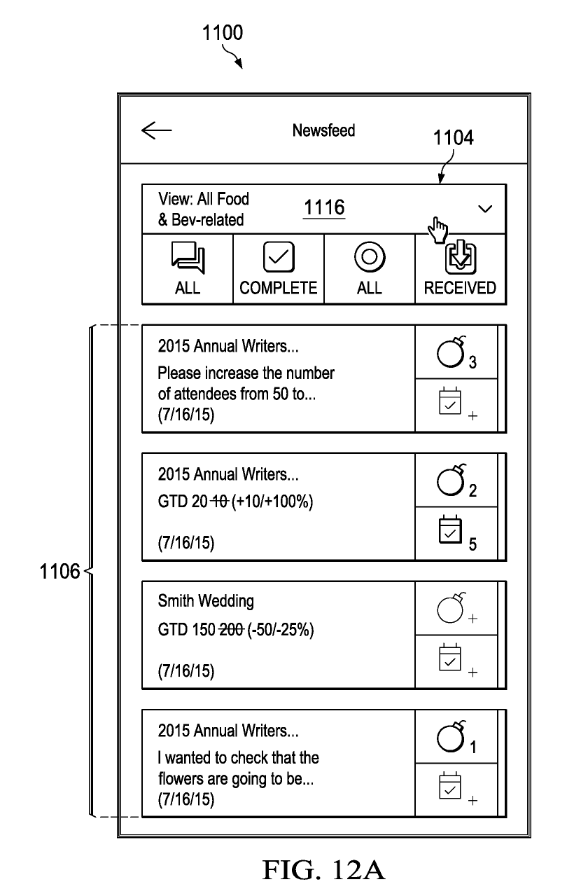

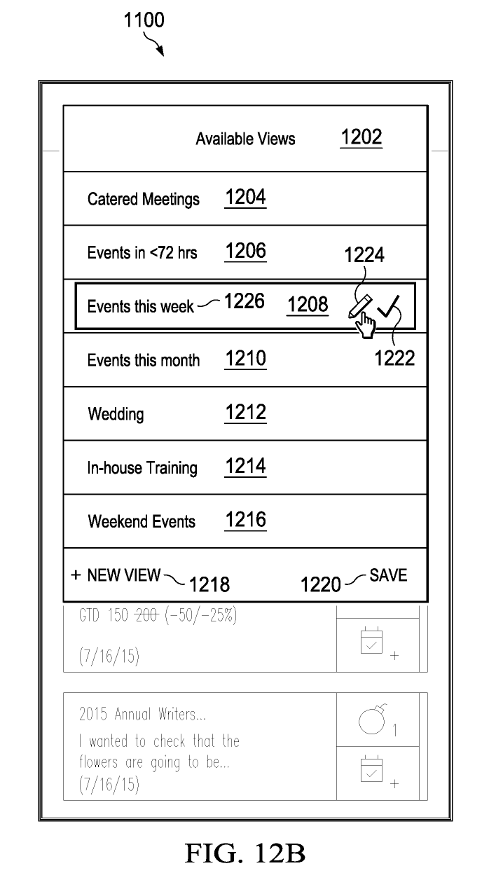

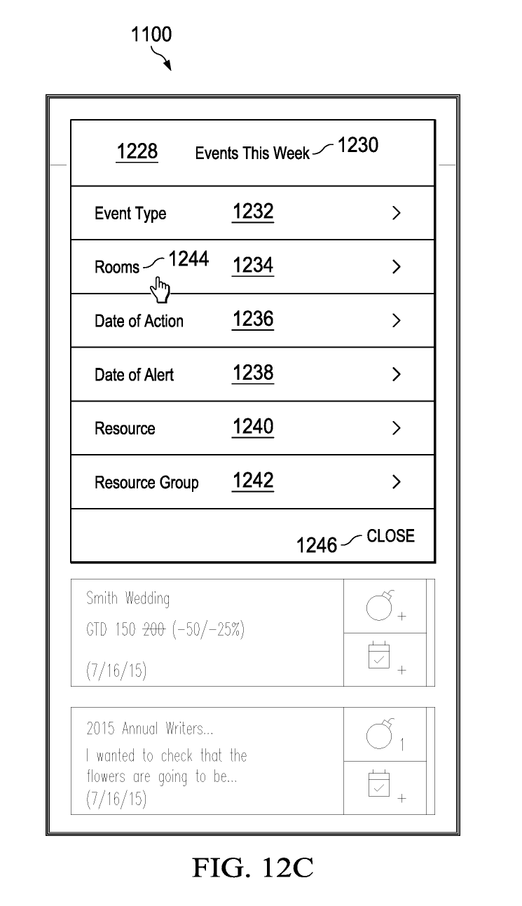

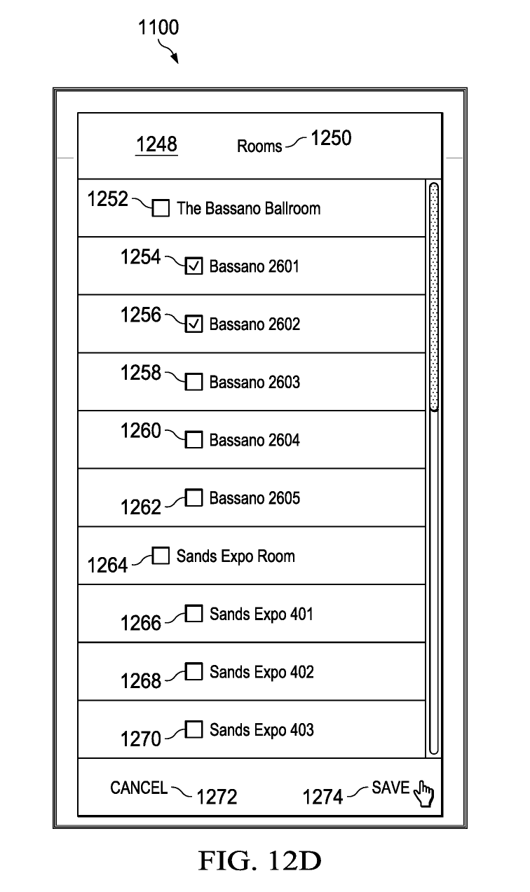

Referring to FIGS. 12A-12D, depict a user interface of an application used by one of users 306 for editing a view.

Display 1100 is a display of the user interface on an application used with cloud event planning software service by a device, such as phone 212 or computer 222.

When view name bar 1116 is selected, title bar 1102, view bar 1104, and newsfeed 1106 are disabled and available views menu 1202 shown in FIG. 12B is displayed. Available views menu 1202 displays one or more views 1204 to 1216 that can be selected and used to sort and filter the items displayed within newsfeed 1106. Available views menu 1202 also provides the option of creating a new view by selecting user interface element 1218 and the option of saving any changes made by selecting user interface element 1220. User interface element 1222, shown as a check, indicates that view 1208 is the view currently being used to filter items in newsfeed 1106. View 1208 includes view name 1226, shown as “Events this week”.

When user interface element 1224 is selected indicating that view 1208 is to be edited, available views menu 1202 is replaced by view edit menu 1228 shown in FIG. 12C. View edit menu 1228 includes title 1230, which matches view name 1226 of the selected view 1208. View edit menu 1228 also includes options 1232 to 1242 to edit the filters used for view 1208 to filter newsfeed items of newsfeed 1106. Option 1234 includes name 1244, shown as “Rooms.” View edit menu 1228 also provides the option of closing view edit menu 1228 and returning to available views menu 1202 by selecting user interface element 1246.

When option 1234 is selected indicating that the “Rooms” filter option is to be updated, view edit menu 1228 is replaced by option menu 1248 shown in FIG. 12D. Option menu 1248 includes title 1250, which matches name 1244 of option 1234. Option menu 1248 also includes one or more options to edit the filter associated with option menu 1248. Specifically, “Rooms” option menu 1248 includes several checkbox user interface elements 1252 to 1270 that allow for selecting one or more rooms or groups of rooms by which to filter the newsfeed items presented in newsfeed 1106. User interface elements 1254 and 1256 are “checked” indicating that newsfeed 1106 will be filtered to only show newsfeed items related to rooms “Bassano 2601” and “Bassano 2602” of the “Bassano Ballroom,” when the “Events this week” filter is activated for the current view. Option menu 1248 also provides the option of canceling any changes made in option menu 1248 and returning to view edit menu 1228 by selecting user interface element 1272 and the option of saving the changes made in option menu 1248 by selecting user interface element 1274.

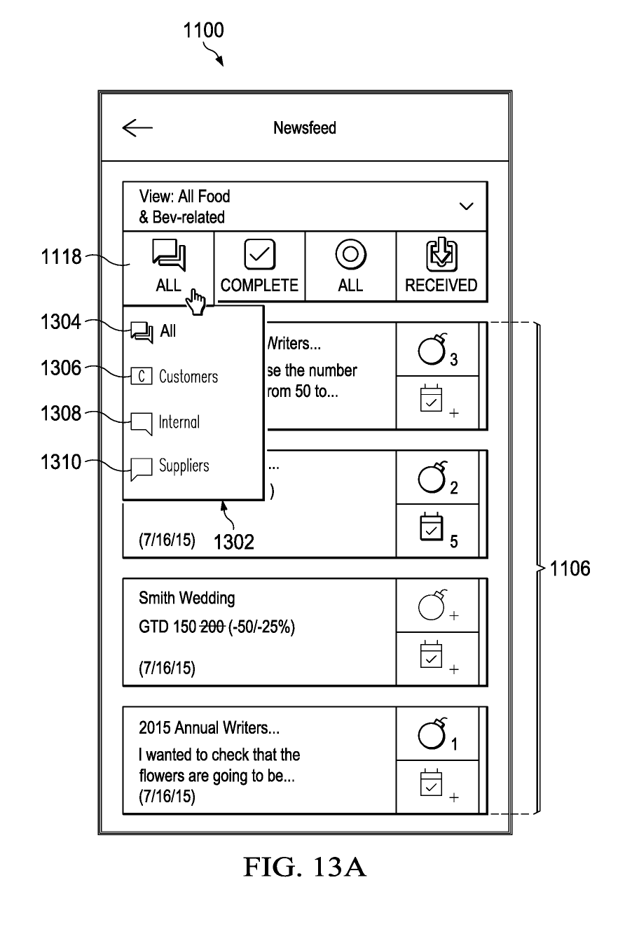

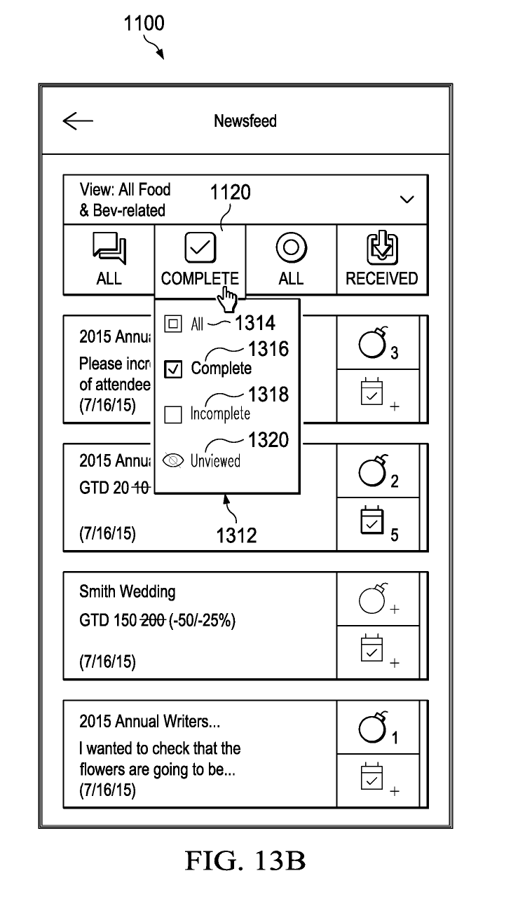

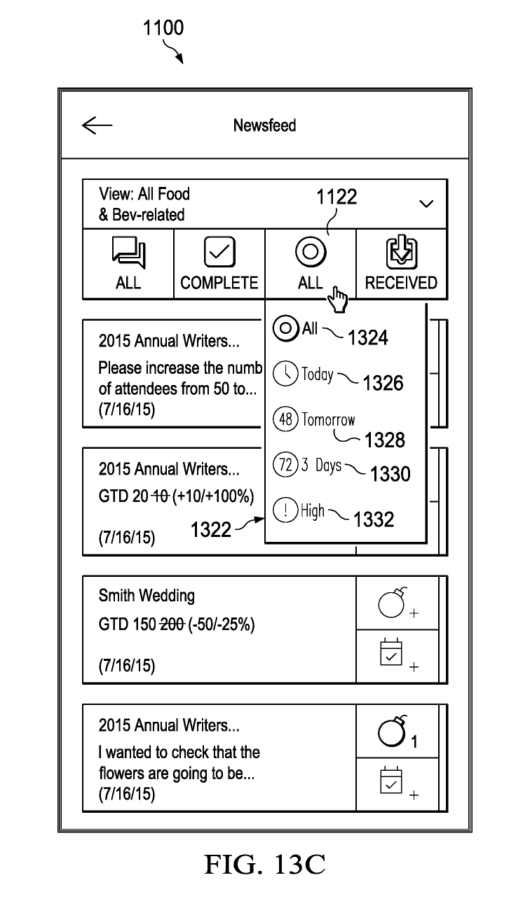

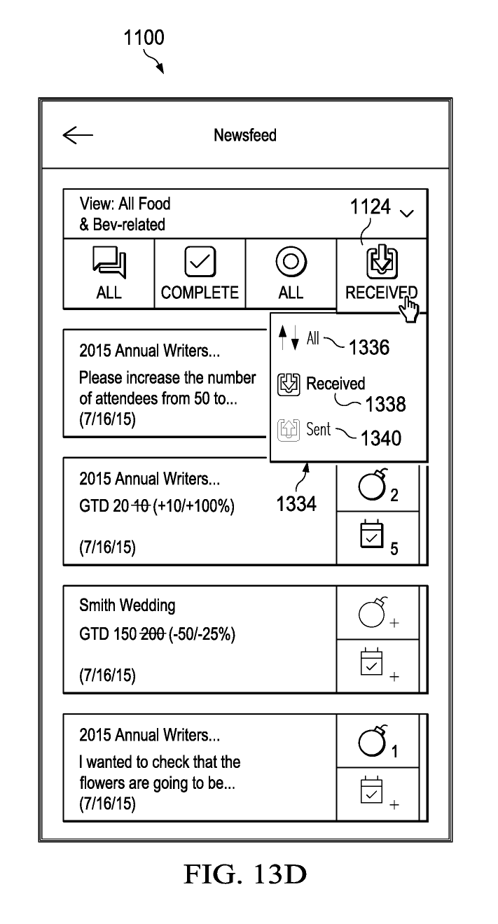

Referring to FIGS. 13A-13D, depict a user interface of an application used by one of users 306 for selecting quick filters of newsfeed items.

Display 1100 is a display of the user interface on an application used with cloud event planning software service by a device, such as phone 212 or computer 222 of FIG. 2.

First quick filter icon 1118 relates to filter options that are associated with the source of the newsfeed items displayed in newsfeed 1106. When first quick filter icon 1118 is selected, first quick filter menu 1302 is displayed. First quick filter menu 1302 (shown in FIG. 13A) includes options 1304 to 1310.

Option 1304 is indicated as the currently selected option of first quick filter menu 1302 for filtering the newsfeed items displayed in newsfeed 1106. When option 1304 is selected, newsfeed 1106 includes newsfeed items that were initiated by users identified as customers, internal users, and/or outside suppliers.

Option 1306 is indicated as not being the currently selected option of first quick filter menu 1302 for filtering the newsfeed items displayed in newsfeed 1106. When option 1306 is selected, newsfeed 1106 includes newsfeed items that were initiated by users identified as customers.

Option 1308 is indicated as not being the currently selected option of first quick filter menu 1302 for filtering the newsfeed items displayed in newsfeed 1106. When option 1308 is selected, newsfeed 1106 includes newsfeed items that were initiated by users identified as internal users that work for the same organization or supplier as the user using the mobile phone app. For example, when the user of the mobile phone app works for the supplier of the venue, selecting option 1308 allows the user to filter out the newsfeed items that were not generated by other users that also work for the supplier of the venue so that newsfeed 1106 only displays the newsfeed items initiated by other users that work for the supplier of the venue.

Option 1310 is indicated as not being the currently selected option of first quick filter menu 1302 for filtering the newsfeed items displayed in newsfeed 1106. When option 1310 is selected, newsfeed 1106 includes newsfeed items that were initiated by users identified as users associated with a different organization or supplier as the user using the mobile phone app. For example, when the user of the mobile phone app works for the supplier of the venue, selecting option 1310 allows the user to filter out the newsfeed items that were generated by users identified as customers or other users of the supplier of the venue so that newsfeed 1106 only displays the newsfeed items initiated by other users associated with the other suppliers that are not employees of the supplier of the venue.

Second quick filter icon 1120 relates to filter options that are associated with the status of tasks associated with the newsfeed items displayed in newsfeed 1106. When second quick filter icon 1120 is selected, second quick filter menu 1312 shown in FIG. 13B is displayed. Second quick filter menu 1312 includes options 1316 to 1320.

Option 1314 is indicated as not being the currently selected option of second quick filter menu 1312 for filtering the newsfeed items displayed in newsfeed 1106. When option 1314 is selected, newsfeed 1106 includes newsfeed items associated with tasks that are complete, incomplete, or are unviewed.

Option 1316 is indicated as the currently selected option of second quick filter menu 1312 for filtering the newsfeed items displayed in newsfeed 1106. When option 1316 is selected, newsfeed 1106 includes newsfeed items associated with tasks that are complete and filters out newsfeed items that are associated with tasks that are incomplete or unviewed. This option can be selected by an employee using the application to show the employee the newsfeed items that include tasks completed by the employee. This option can also be selected by a manager using the application to show the manager the newsfeed items that include tasks completed by employees that report to the manager.

Option 1318 is indicated as not being the currently selected option of second quick filter menu 1312 for filtering the newsfeed items displayed in newsfeed 1106. When option 1318 is selected, newsfeed 1106 includes newsfeed items associated with tasks that are incomplete and filters out newsfeed items that are associated with tasks that are complete. This option can be selected by an employee using the application to show the employee the newsfeed items that include tasks that have not been completed by the employee. This option can also be selected by a manager using the application to show the manager the newsfeed items that include tasks that have not been completed by employees that report to the manager.

Option 1320 is indicated as not being the currently selected option of second quick filter menu 1312 for filtering the newsfeed items displayed in newsfeed 1106. When option 1320 is selected, newsfeed 1106 includes newsfeed items associated with tasks that are unviewed. This option can be selected by an employee using the application to show the employee the newsfeed items that include tasks that have not been viewed by the employee. This option can also be selected by a manager using the application to show the manager the newsfeed items that include tasks that have not been viewed by employees that report to the manager.

Third quick filter icon 1122 relates to filter options that are associated with when an event occurs or whether an event is a high priority event. When third quick filter icon 1122 is selected, third quick filter menu 1322 shown in FIG. 13C is displayed. Third quick filter menu 1322 includes options 1324 to 1332.

Option 1324 is indicated as the currently selected option of third quick filter menu 1322 for filtering the newsfeed items displayed in newsfeed 1106. When option 1324 is selected, newsfeed 1106 includes all newsfeed items, regardless of when the event associated with a particular newsfeed item is to occur.

Option 1326 is indicated as not being the currently selected option of third quick filter menu 1322 for filtering the newsfeed items displayed in newsfeed 1106. When option 1326 is selected, newsfeed 1106 includes newsfeed items associated with events that occur “today” or within the next twenty four hours and filters out events to do not occur “today” or within the next twenty four hours.

Option 1328 is indicated as not being the currently selected option of third quick filter menu 1322 for filtering the newsfeed items displayed in newsfeed 1106. When option 1328 is selected, newsfeed 1106 includes newsfeed items associated with events that occur “tomorrow” or within the next forty eight hours and filters out events to do not occur “tomorrow” or within the next forty eight hours.

Option 1330 is indicated as not being the currently selected option of third quick filter menu 1322 for filtering the newsfeed items displayed in newsfeed 1106. When option 1330 is selected, newsfeed 1106 includes newsfeed items associated with events that occur within the next three days or seventy two hours and filters out events to do not occur within the next three days or seventy two hours.

Option 1332 is indicated as not being the currently selected option of third quick filter menu 1322 for filtering the newsfeed items displayed in newsfeed 1106. When option 1332 is selected, newsfeed 1106 includes newsfeed items associated with events that are indicated as high priority events, regardless of when the events occur, and filters out events that are not indicated as high priority events.

Fourth quick filter icon 1124 relates to filter options that are associated with whether the user of the application initiated the change request associated with the newsfeed item. When fourth quick filter icon 1124 is selected, fourth quick filter menu 1334 shown in FIG. 13D is displayed. Fourth quick filter menu 1334 includes options 1336 to 1340.

Option 1336 is indicated as not being the currently selected option of fourth quick filter menu 1334 for filtering the newsfeed items displayed in newsfeed 1106. When option 1336 is selected, newsfeed 1106 is not filtered based on whether the user of the application initiated the change request associated with a newsfeed item.

Option 1338 is indicated as the currently selected option of fourth quick filter menu 1334 for filtering the newsfeed items displayed in newsfeed 1106. When option 1338 is selected, newsfeed 1106 includes newsfeed items associated with change requests that were not initiated by the user of the application.

Option 1340 is indicated as not being the currently selected option of fourth quick filter menu 1334 for filtering the newsfeed items displayed in newsfeed 1106. When option 1340 is selected, newsfeed 1106 includes newsfeed items associated with change requests that were initiated by the user of the application.

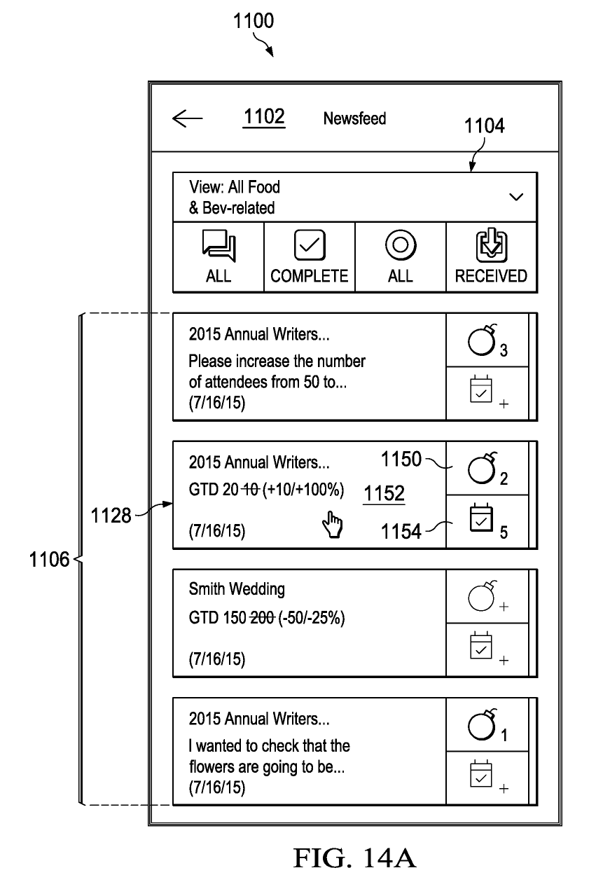

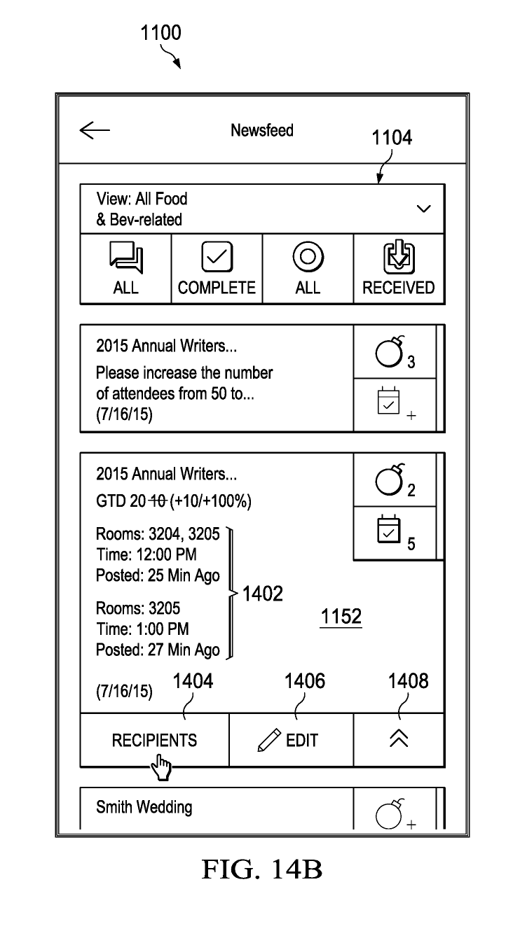

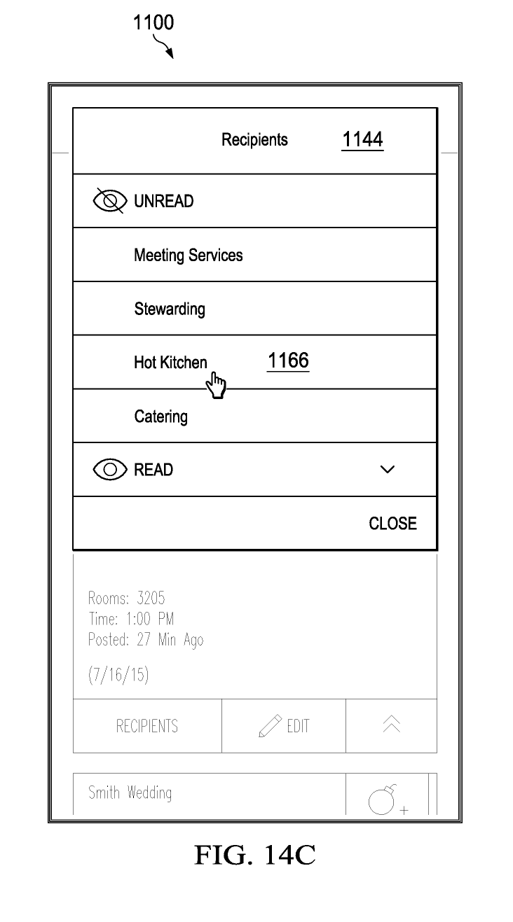

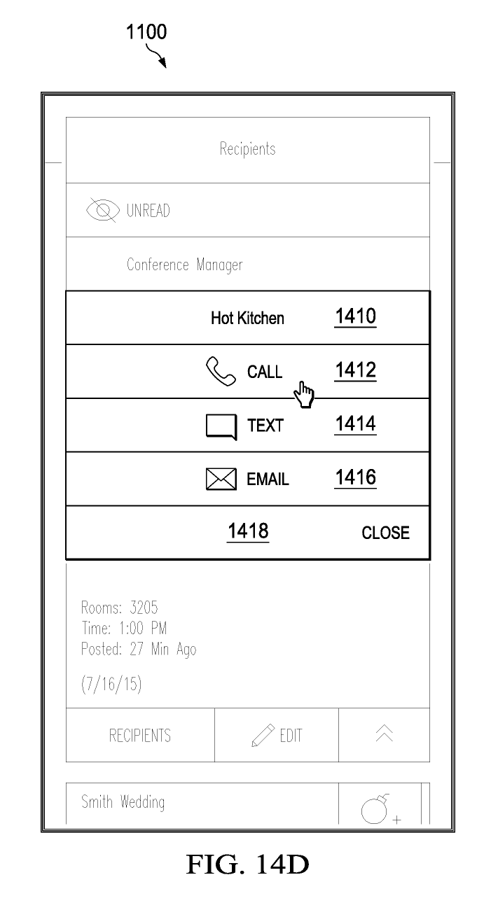

Referring to FIGS. 14A-14D, depict a user interface of an application used by one of users 306 for viewing recipients of a newsfeed item.

Display 1100 is a display of the user interface on an application used with cloud event planning software service by a device, such as phone 212 or computer 222.

Second newsfeed item 1128 includes alerts icon 1150, description 1152, and tasks icon 1154.

When description 1152 of second newsfeed item 1128 is selected shown in FIG. 14A, such as by a mouse click or a touch gesture, the display of second newsfeed item 1128 expands to show additional information 1402 shown in FIG. 14B and user interface elements including recipients element 1404, edit element 1406 and up arrow element 1408. Additional information 1402 shows more detailed information about the change request associated with newsfeed item 1128 including changes to the rooms and times for the event. Interaction with recipients element 1404 allows a user to view the recipients of newsfeed item 1128. Interaction with edit element 1406 allows a user to edit the change request related to newsfeed item 1128. Interaction with up arrow element shrinks the display of description 1152 back to its original size without additional information 1402.

When recipients element 1404 is selected, title bar 1102, view bar 1104, and newsfeed 1106 are disabled and recipients menu 1144 shown in FIG. 14C is displayed. Recipients menu 1144 displays the users, departments, and suppliers that are recipients associated with newsfeed item 1128. Recipients menu 1144 sorts the display of the recipients by whether the newsfeed item has been read or is unread and display the group of recipients who have not read newsfeed item 1126.

Recipients menu 1144 includes recipient 1166, named “Hot Kitchen”.

When recipient 1166 is selected from recipients menu 1144, recipients menu is disabled and contact menu 1410 shown in FIG. 14D is displayed. The title of contact menu 1410 is the same as the name of recipient 1166 (“Hot Kitchen”) and contact menu 1410 includes one or more contact options, including contact options 1412 to 1416. Selection of contact option 1412 allows for a phone call to be initiated with the user identified by recipient 1166. Selection of contact option 1414 allows for a text message to be sent to the user identified by recipient 1166. Selection of contact option 1416 allows for an email message to be sent to the user identified by recipient 1166.

Contact menu 1410 also includes close element 1418 that, when selected, closes contact menu 1410 and returns to the prior screen, which is recipients menu 1144.

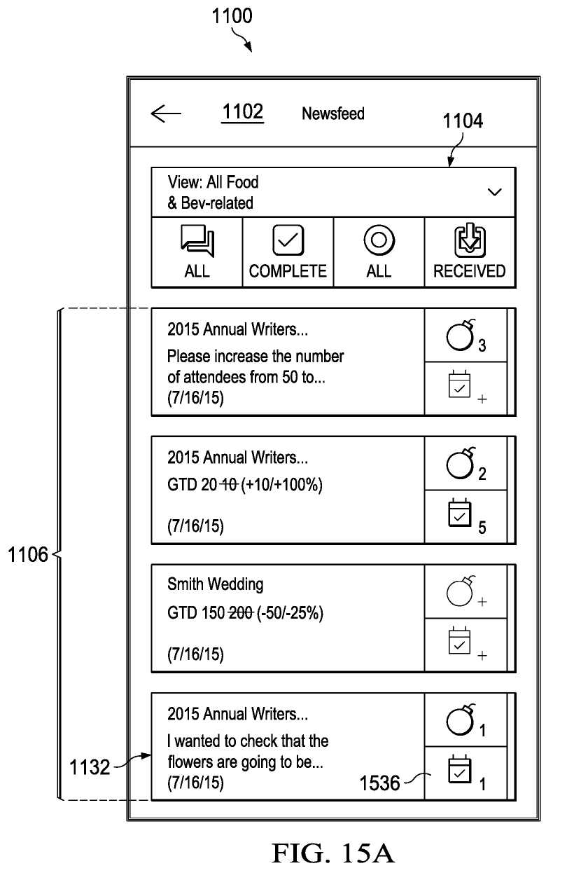

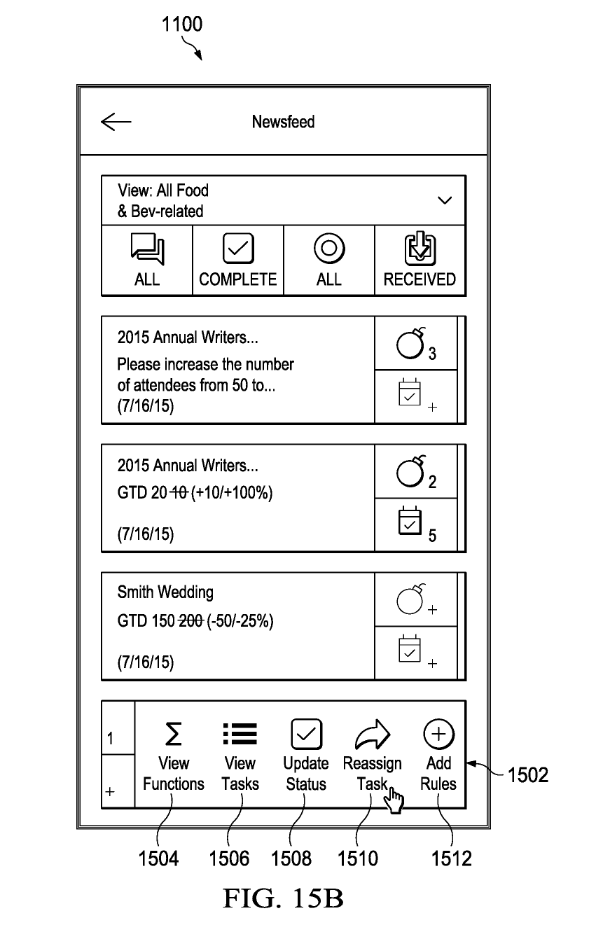

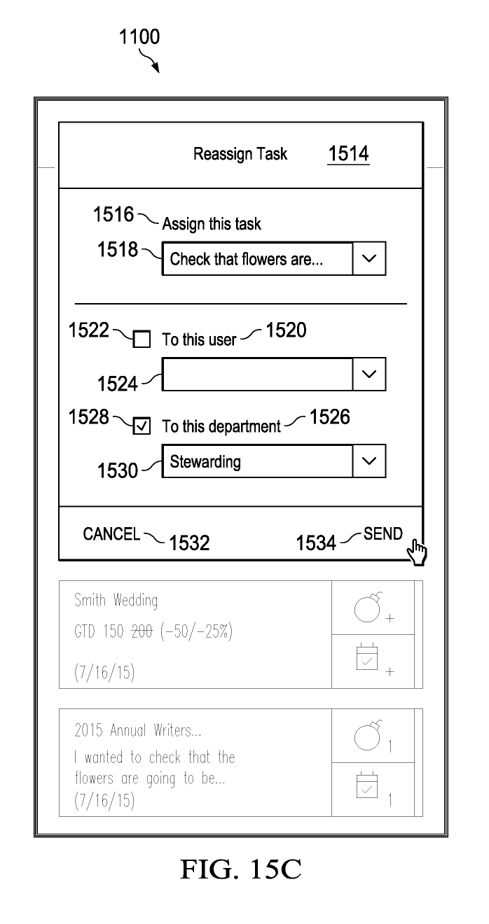

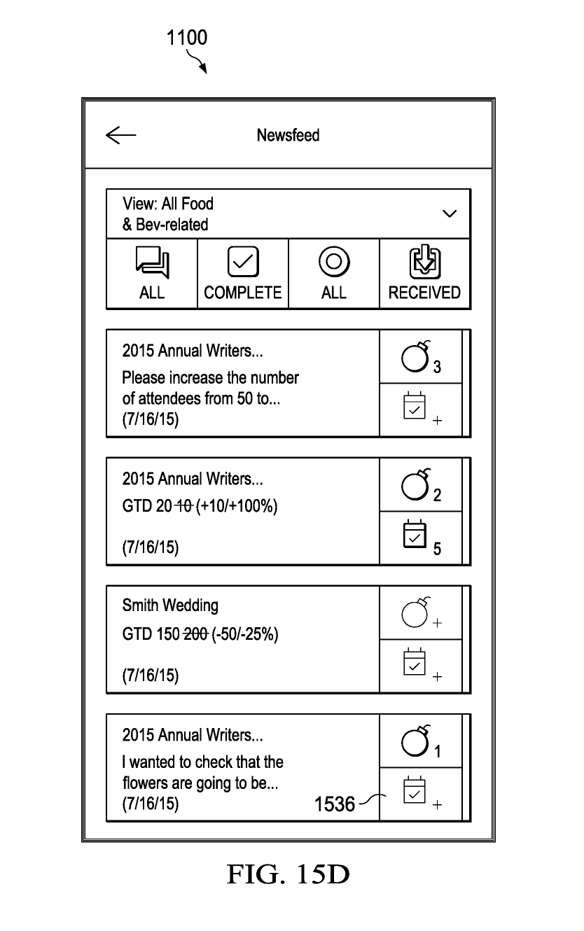

Referring to FIGS. 15A-15D, depict a user interface of an application used by one of users 306 for reassigning a task.

Display 1100 is a display of the user interface on an application used with cloud event planning software service by a device, such as phone 212 or computer 222.

In FIG. 15A, the number in tasks icon 1536 of newsfeed item 1132 indicates that one task is assigned to the user of the application

When newsfeed item 1132 is dragged to the left, slide menu 1502 shown in FIG. 15B for newsfeed item 1132 is displayed. Slide menu 1502 includes several menu options, including options 1504 to 1512. The functionality of options 1504 to 1512 is associated with and context sensitive to newsfeed item 1132. Selection of view functions option 1504 allows the user of the application to view functions that are associated with newsfeed item 1132. Selection of view tasks option 1506 allows the user of the application to view the tasks associated with newsfeed item 1132. Update status option 1508 allows the user of the application to update the status of a task associated with newsfeed item 1132. Reassign task option 1510 allows the user of the application to reassign tasks associated with newsfeed item 1132. Add rules option 1512 allows the user of the application to add rules for handling change requests and tasks related to newsfeed item 1132.

When reassign task option 1510 is selected from slide menu 1502, title bar 1102, view bar 1104, and newsfeed 1106 are disabled and reassign task menu 1514 shown in FIG. 15C, is displayed. Reassign task menu 1514 allows for identifying a task to reassign and allows for identifying one or more users to whom the task will be reassigned through the use of one or more user interface elements 1516 to 1530.

Text element 1516 indicates to the user of the application that dropdown element 1516 is used to identify which task will be reassigned. Dropdown element 1516 is populated with the tasks associated with newsfeed item 1132 that are assigned to the user of the application.

Text element 1520 indicates to the user of the application that check box element 1522 and dropdown element 1524 are used to identify a user to whom the task will be reassigned. Dropdown element 1524 is populated with the names of users to which the user of the application can assign tasks. Checkbox element 1522 being unchecked indicates that the task will not be assigned to another user.

Text element 1526 indicates to the user of the application that check box element 1528 and dropdown element 1530 are used to identify a department to whom the task will be reassigned. Dropdown element 1530 is populated with the names of departments to which the user of the application can assign tasks. Checkbox element 1528 being checked indicates that the task will be assigned to the department identified in dropdown element 1530.

Reassign task menu 1514 includes cancel element 1532 that, when selected, closes reassign task menu 1514 without reassigning the task identified in dropdown element 1518 and returns to the prior screen, which re-enables title bar 1102, view bar 1104, and newsfeed 1106.

Reassign task menu 1514 includes send element 1534 that, when selected, sends the task identified in dropdown element 1518 to the user identified by the dropdown element 1524 when checkbox element 1522 is selected and sends the task identified in dropdown element 1518 to the department identified by the dropdown element 1530 when checkbox element 1528 is selected.

When send element 1534 is selected and the task is successfully sent, the number in tasks icon 1536 of newsfeed item 1132 is updated in FIG. 15D to a plus sign to indicate that no tasks is assigned to the user of the application in relation to newsfeed item 1132.

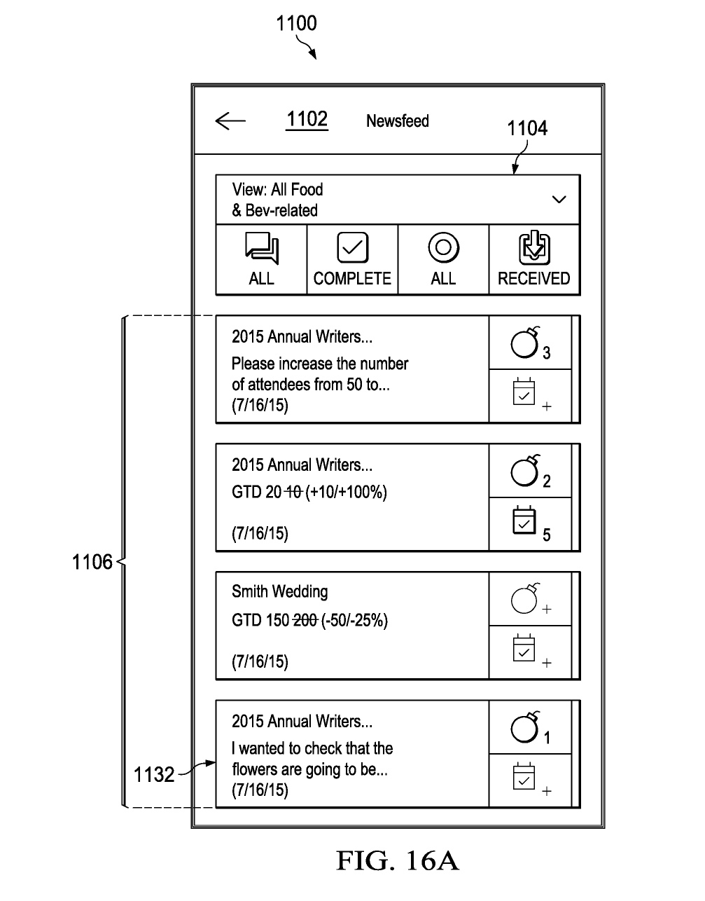

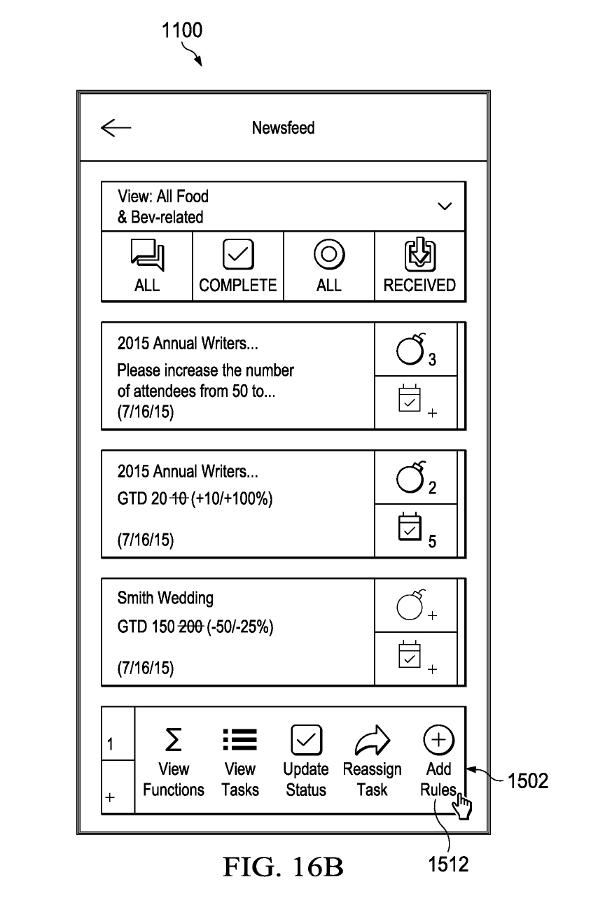

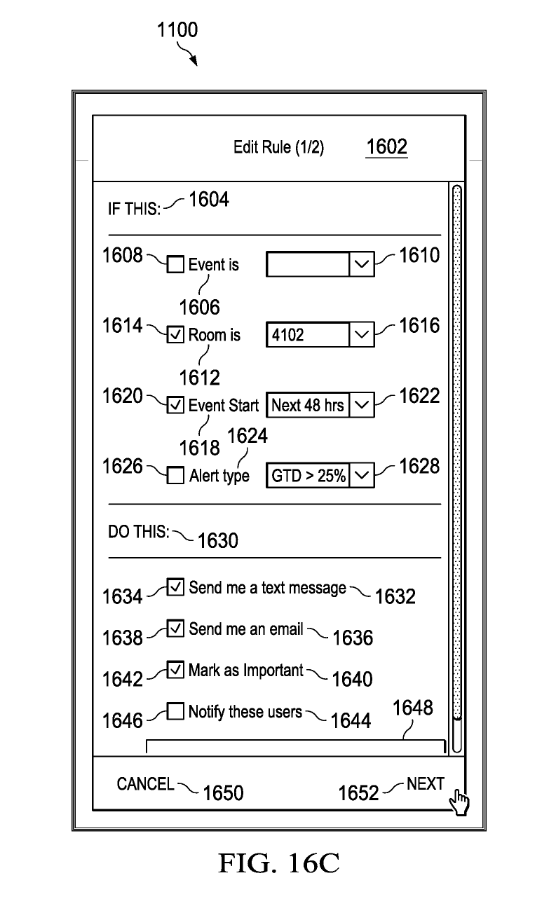

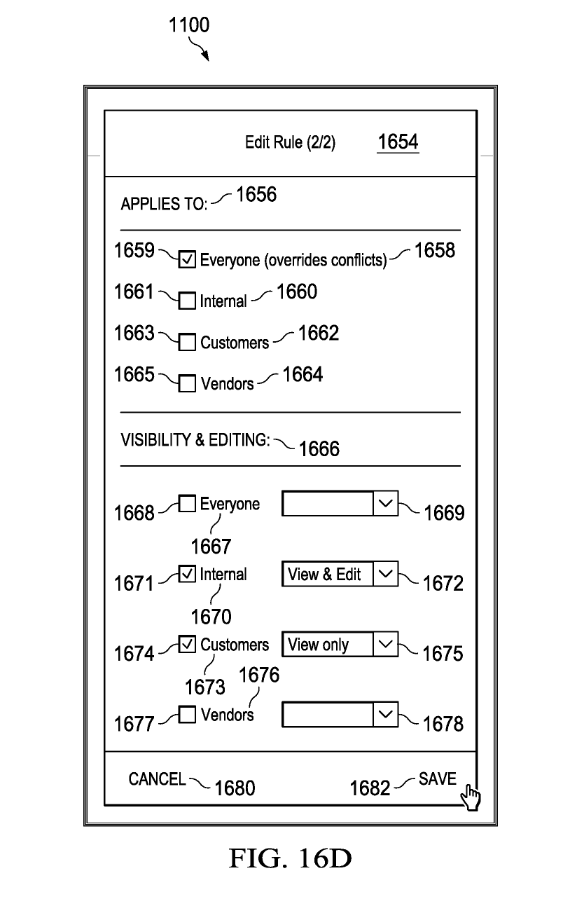

Referring to FIG. 16A-16D, depict a user interface of an application used by one of users 306 for adding rules.

Display 1100 is a display of the user interface on an application used with cloud event planning software service by a device, such as phone 212 or computer 222.

When newsfeed item 1132 is dragged to the left, slide menu 1502 shown in FIG. 16B for newsfeed item 1132 is displayed. When add rules option 1512 is selected from slide menu 1502, title bar 1102, view bar 1104, and newsfeed 1106 are disabled and first rule menu 1602 shown in FIG. 16C, is displayed. First rule menu 1602 allows for setting conditions to trigger a rule with user interface elements 1604 to 1628 and allows for setting actions to perform with user interface elements 1630 to 1644 when the rule is triggered.

Text element 1604 indicates to the user of the application that user interface elements 1606 to 1628 are used to identify the conditions for triggering a rule.

Text element 1606 indicates to the user of the application that checkbox element 1608 and dropdown element 1610 are used to create a condition related to the event associated with newsfeed item 1132. Checkbox element 1608 being unchecked indicates that the item selected in dropdown element 1610 will not be used as a condition for triggering the rule being created.

Text element 1612 indicates to the user of the application that checkbox element 1614 and dropdown element 1616 are used to create a condition related to the room associated with newsfeed item 1132. Checkbox element 1614 being checked indicates that the item selected in dropdown element 1616—room number 4102—will be used as a condition for triggering the rule being created.

Text element 1618 indicates to the user of the application that checkbox element 1620 and dropdown element 1622 are used to create a condition related to the start time of the event associated with newsfeed item 1132. Checkbox element 1620 being checked indicates that the item selected in dropdown element 1622—a start time with the next forty eight hours—will be used as a condition for triggering the rule being created.

Text element 1624 indicates to the user of the application that checkbox element 1626 and dropdown element 1628 are used to create a condition related an alert that is or can be associated with newsfeed item 1132. Checkbox element 1626 being unchecked indicates that the item selected in dropdown element 1628—a guaranteed item that increases by more than 25%—will not be used as a condition for triggering the rule being created.

Text element 1630 indicates to the user of the application that user interface elements 1632 to 1646 are used to identify the actions performed when a rule is triggered by one or more conditions.

Text element 1632 indicates to the user of the application that checkbox element 1634 is used to create an action performed when one or more conditions are met. Checkbox element 1634 being checked indicates that the system will perform the action of sending a text message to the user of the application when the conditions are met and the rule is triggered.

Text element 1636 indicates to the user of the application that checkbox element 1638 is used to create an action performed when one or more conditions are met. Checkbox element 1638 being checked indicates that the system will perform the action of sending an email to the user of the application when the conditions are met and the rule is triggered.

Text element 1640 indicates to the user of the application that checkbox element 1642 is used to create an action performed when one or more conditions are met. Checkbox element 1642 being checked indicates that the system will perform the action of marking the newsfeed item as an important newsfeed item when the conditions are met and the rule is triggered.

Text element 1644 indicates to the user of the application that checkbox element 1646 and dropdown element 1648 are used to create an action performed when one or more conditions are met. Checkbox element 1646 being unchecked indicates that the system will not perform the action of notifying the users, departments, or suppliers identified in dropdown element 1648 when the conditions are met and the rule is triggered.

First rule menu 1602 includes cancel element 1650 that, when selected, closes first rule menu 1602 without saving the rule being created and returns to the prior screen, which re-enables title bar 1102, view bar 1104, and newsfeed 1106. First rule menu 1602 also includes next element 1652 that, when selected, displays second rule menu 1654 shown in FIG. 16D.

Second rule menu 1654 allows for indicating to whom the rule applies with user interface elements 1656 to 1665 and allows for identifying which users can view and edit the rule with user interface elements 1666 to 1678.

Text element 1656 indicates to the user of the application that user interface elements 1658 to 1665 are used to identify to whom the rule applies.

Text element 1658 indicates to the user of the application that checkbox element 1659 is used identify to whom the rule applies. Checkbox element 1659 being checked indicates that the rule will be applied to all users associated with newsfeed item 1132 and override conflicts.

Text element 1660 indicates to the user of the application that checkbox element 1661 is used identify to whom the rule applies. Checkbox element 1661 being unchecked indicates that the rule will not be applied to internal users associated with newsfeed item 1132 (unless checkbox element 1659 is selected).

Text element 1662 indicates to the user of the application that checkbox element 1663 is used identify to whom the rule applies. Checkbox element 1663 being unchecked indicates that the rule will not be applied to users identified as customers associated with newsfeed item 1132 (unless checkbox element 1659 is selected).

Text element 1664 indicates to the user of the application that checkbox element 1665 is used identify to whom the rule applies. Checkbox element 1665 being unchecked indicates that the rule will not be applied to users identified as customers associated with newsfeed item 1132 (unless checkbox element 1659 is selected).

Text element 1666 indicates to the user of the application that user interface elements 1667 to 1678 are used to identify to which users can view an edit the rule.

Text element 1667 indicates to the user of the application that checkbox element 1668 and dropdown element 1669 are used to identify users that can see and edit the rule associated with newsfeed item 1132. Checkbox element 1668 being unchecked indicates that the permissions indicated in dropdown element 1669 will not be given to all users.

Text element 1670 indicates to the user of the application that checkbox element 1671 and dropdown element 1672 are used to identify users that can see and edit the rule associated with newsfeed item 1132. Checkbox element 1671 being checked indicates that the permissions indicated in dropdown element 1672—view and edit permissions—will be given to internal users.

Text element 1673 indicates to the user of the application that checkbox element 1674 and dropdown element 1675 are used to identify users that can see and edit the rule associated with newsfeed item 1132. Checkbox element 1674 being checked indicates that the permissions indicated in dropdown element 1675—view only permissions—will be given to users identified as customers.

Text element 1676 indicates to the user of the application that checkbox element 1677 and dropdown element 1678 are used to identify users that can see and edit the rule associated with newsfeed item 1132. Checkbox element 1677 being unchecked indicates that the permissions indicated in dropdown element 1678 will not be given to users identified as customers.

Second rule menu 1654 includes cancel element 1680 that, when selected, closes second rule menu 1602 and returns to the prior screen, first rule menu 1602. Second rule menu 1654 also includes save element 1652 that, when selected, saves the rule being created and re-enables title bar 1102, view bar 1104, and newsfeed 1106.

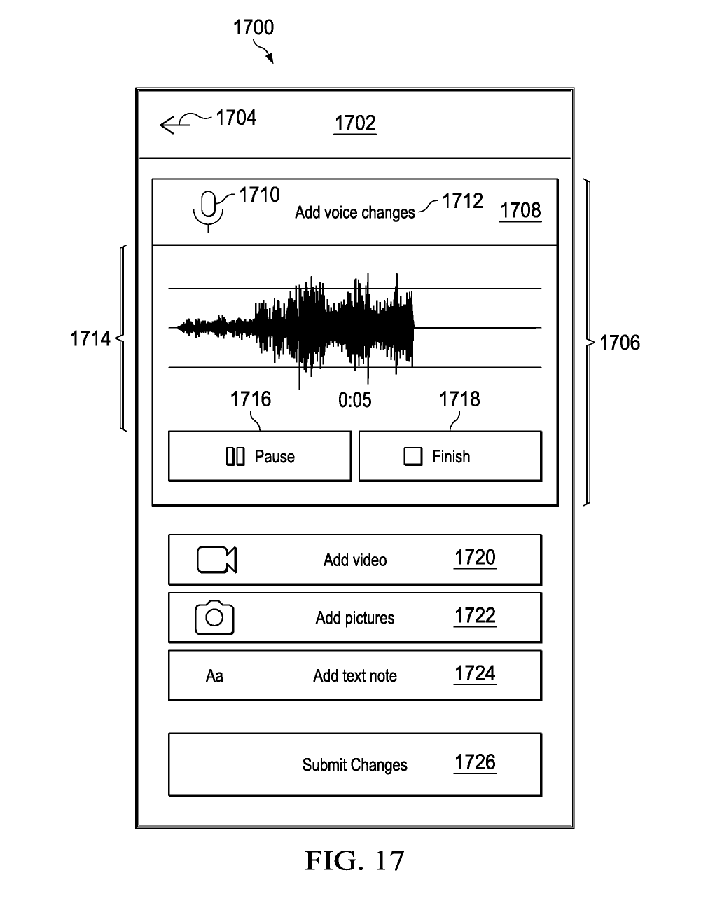

Referring to FIG. 17, depicts a user interface for adding voice, video, pictures, and text to a change request and/or an update to a change request.

Display 1700 is a screen of an application used to create or update a change request on a device, such as a mobile phone. Display 1700 shows the application prior to the change request or update being sent by the application to a server. Display 1700 includes title bar 1702, action window 1706, selection buttons 1720, 1722, and 1724, and submission button 1726.

Title bar 1702 includes back arrow 1704. Selection of back arrow 1714 will transition the application back to the prior screen. In alternative embodiments, title bar 1702 includes text that indicates the name of the application.

Action window 1706 includes title bar 1708, visualization window 1714, and control buttons 1716 and 1718. Title bar 1708 of action window 1706 includes image 1710 and text 1712. Image 1710 shows a microphone and text 1712 states “Add voice changes” to indicate that a voice recording was selected to be included or associated with the change request or update.

Visualization window 1714 provides a visualization of media that is recorded. Visualization window 1714 includes a time domain display of the amplitude of the recorded voice message along with the number of seconds that have been recorded.

Control buttons 1716 and 1718 each include an image and text to indicate their respective functions. Control button 1716 is a pause button that, when selected, pauses a current recording. Control button 1718 is a finish button that, when selected, finishes the current recording by closing the audio file of the recording so that the audio file may be attached to or associated with the change request or update. After finishing a first voice message, one or more additional voice messages can be recorded and attached to the change request or update.

In alternative embodiments, one or more of control buttons 1716 and 1718 transition between multiple states. For example, control button 1716 may transition between start, pause, and continue commands to start, pause, and continue recording a voice message. With each different state, the image and text on the control button 1716 is updated to indicate the current function of control button 1716.

Action window 1706 is context sensitive based on the type of media selected. Visualization window 1714 and control buttons 1716 and 1718 are updated based on the type of media that is selected to be included with the change request or update.

Selection buttons 1720, 1722, and 1724 allow for selecting different types of media to add to the change request or update. Selection button 1720 allows for adding video, selection button 1722 allows for adding pictures, and selection button 1724 allows for adding a text note or message.

When one of selection buttons 1720, 1722, and 1724 is selected, action window 1706 is updated to allow for creating or selecting the type of media indicated by the text of the selection button that was selected. When selection button 1720 is selected, action window 1706 is updated to allow for creating or selecting video. When selection button 1722 is selected, action window 1706 is updated to allow for creating or selecting pictures. When selection button 1724 is selected, action window 1706 is updated to allow for creating text or selecting a file with text.

In alternative embodiments, when different selection buttons are selected, action window 1706 is updated to cater to the type of media selected and one or more of selection buttons 1720, 1722, and 1724 are updated to allow for selection of different media. For example, when action window 1706 is for adding voice changes and selection button 1720 for adding video is selected, action window 1706 is changed to allow for recording video and selection button 1720 is changed to allow for the selection of adding voice changes.

In alternative embodiments selection buttons 1720, 1722, and 1724 activate other applications on the device running the application. The other applications are used to create or select one or more media files that are attached to or associated with the change request or update.

Submission button 1726 allows for the submission of the change request or update. When selected, submission button 1726 associates the created and/or selected media files (voice, video, images, text, and so on) with the change request or update and submits the change request or update to the cloud event planning software service, similar to step 908 of FIG. 9 when user 902 sends a change request to server 904, and similar to step 934 of FIG. 9 when user 902 sends updates to server 904. In certain embodiments, selection of submission button 1726 closes down one or more other applications that were opened to create or select the media files associated with the change request or update.

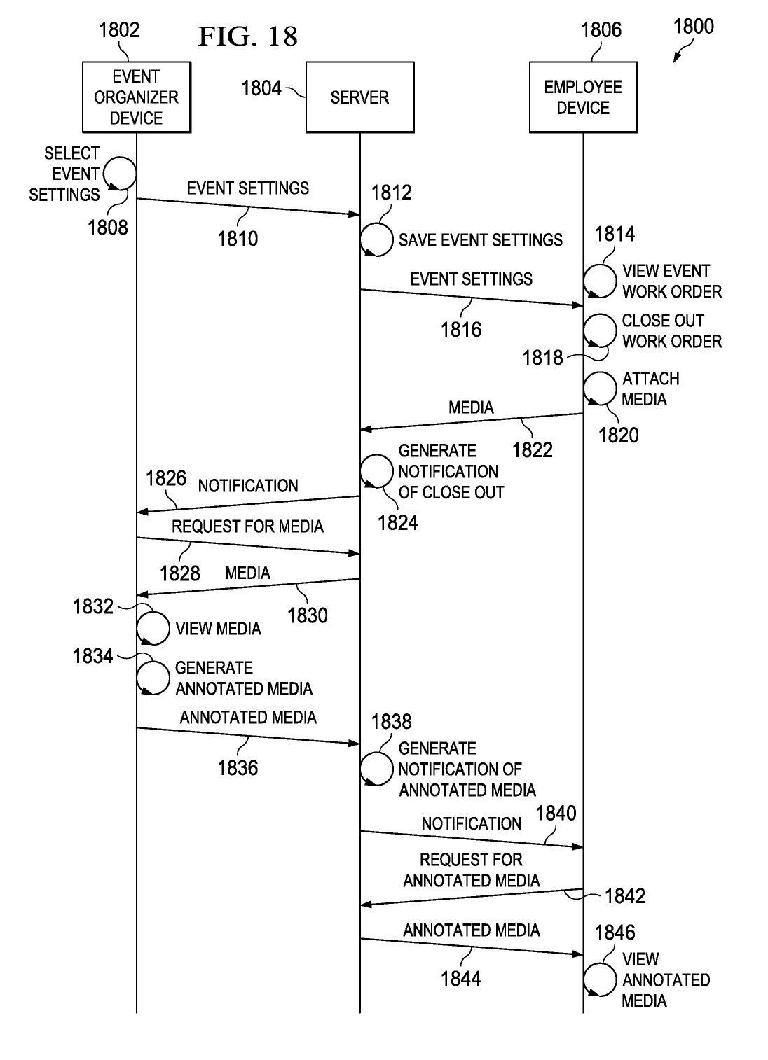

FIG. 18 is a sequence diagram that illustrates closing out a work order using annotated media. Sequence 1800 involves event organizer device 1802, server 1804, and employee device 1806. In a preferred embodiment, event coordinator device 1802 is an embodiment of devices 210 or 212 used by event organizer 208 of FIG. 2, server 1804 is an embodiment of cloud event server 204 of cloud event planning service 202 of FIG. 2, and employee device 1806 is an embodiment of devices 222 and 224 of first supplier 214 of FIG. 2.

In a preferred embodiment, for each step depicted in sequence 1800, one or more messages, packets, and protocols are used. Protocols include user datagram protocol (UDP), transmission control protocol/internet protocol (TCP/IP), session initiation protocol (SIP), hypertext transfer protocol (HTTP), hypertext transfer protocol secure (HTTPS), and others, which allow data to be sent and received by the devices connected in a network, such as those shown in FIG. 2 and in FIG. 18.

Whenever a device sends a message, notification, packet, or data via one or more networks and protocols, the device transforms from a first state in which the data has not been sent into a second state in which the data has been sent. Whenever the device receives a message, notification, packet, or data via one or more networks and protocols, the device transforms from a first state in which the data has not been received and is not available on the device into a second state in which the data has been received and is available on the device.

At step 1808, the event organizer selects one or more event settings related to a work order. The event organizer can select whether a notification will be generated and sent to event organizer device 1802 when a work order is closed out. The event organizer can also select which, if any, types of media must be included in order to close out a work order of an event. The types of media include video, audio, and text. A close out of a work order is a status update to an event stored, for example, by cloud event server 204 and can appear as a newsfeed item.

At step 1810, the settings selected with event organizer device 1802 are sent from event organizer device 1802 to server 1804. At step 1812, server 1804 saves the event settings received from event organizer device 1802 to the work order associated with the settings.

At step 1814, an employee views the event work order associated with the settings. At step 1816, server 1804 sends the settings related to the work order to employee device 1806 and the settings are received by employee device 1806.

At step 1818, the employee attempts to close out the work order after completing the work required by the work order for the event. As an example, when the event is a wedding reception in a banquet room of a hotel, the employee of the hotel is tasked with setting up the tables, chairs, and floral arrangements. After setting up the tables, chairs and floral arrangements, the employee uses employee device 1806 to close out the work order. When the employee attempts to close out the work order, the application running on employee device 1806 indicates that the event organizer has requested specific media to be provided in order to close out the work order. As an example, the specific media is a video of the completed set up of the banquet room.

In a preferred embodiment, employee device 1806 is used to create a video as the media. Employee device 1806 is used to record the state of the banquet room, including the positioning and placement of the tables, chairs, floral arrangements, and any other items specified by the work order for the event. By creating a video, the state of the banquet room is transformed into media or video data that is stored as a digital representation on the device, such as in a moving picture experts group (MPEG) file on employee device 1806. At step 1820, the employee attaches the requested media to the close out of the work order.

At step 1822, employee device 1806 sends the media to server 1804 to close out the work order for the event and server 1804 receives the media from employee device 1806.

At step 1824, in response to receiving the close out of the event and the required media, server 1804 checks the settings of the event to determine if a notification should be generated for the event organizer and sent to event organizer device 1802. When the event settings indicate that a notification should be generated an in response to receiving the required media, server 1804 generates a notification of the close out of the work order.

At step 1826, the notification generated by server 1804 is sent from server 1804 to event organizer device 1802 and is received by event organizer device 1802. The notification is displayed on event organizer device 1802. In response to the notification, the event organizer can use event organizer device 1802 to retrieve and view the media attached to the close out of the work order.

At step 1828, event organizer device 1802 sends a request for the media attached to the close out of the work order to server 1804 and the request for the media is received by server 1804.

At step 1830, upon receiving the request for the media associated with the close out of the work order, server 1804 sends the media to event organizer device 1802. Event organizer device 1802 receives the media sent from server 1804.

At step 1832, after receiving the media from server 1804, event organizer device 1802 plays the media for the event organizer. While viewing, listening to, or reading the media that was attached to the close out of the work order, the event organizer can use event organizer device 1802 to pause the playback.

At step 1834, event organizer device 1802 generates annotated media. The annotated media combines the original media that was associated with the close out of the work order with additional media, such as images, videos, audio, and text. For example, during playback of a video of a banquet room, when the event organizer notices that the table linens are not the correct color, the event organizer can pause the video playback of the original media and record additional audio to state that the table linens are not the correct color. The original video and the additional audio are combined to form the annotated media. The event organizer may point out things that are not correct or do not meet expectations. The event organizer may also give praise for things that are correct and exceed expectations.

In a preferred embodiment, the original media is a video and the annotations are audio annotations. The annotated media is created by one or a combination of mixing the audio annotations in with the original audio layer of the media or replacing the original audio layer in the media with the audio annotations. When the original video is paused and audio annotations are recorded, the annotated video shows a freeze frame of the original video where the original video was paused for the length of the audio annotation. When the original video is not paused while the audio annotation is being recorded, the annotated media is created by using the original video and mixing or replacing the original audio layer with the audio annotations. The mixing or replacing is performed by one of event organizer device 1802 or server 1804. The annotated media includes metadata that identifies the start point of each annotation to allow a viewer of the annotated media to quickly skip to the points in the annotated media where the audio annotations begin.

In a preferred embodiment, dead air that leads or trails the audio annotation is removed before the audio annotations are combined with the original video. Examples of dead air include when there is a leading 5 second pause between when a record annotation button is pushed and when the user speaks, and include when there is a trailing 5 second pause after the user stops speaking before the stop record button is pushed. This dead air is removed from the audio annotations by either event organizer device 1802 or server 1804 before being combined with the original video to form annotated media.

At step 1836, the annotated media generated by event organizer device 1802 is sent from event organizer device 1802 to server 1804 and is received by server 1804.

At step 1838, in response to receiving the annotated media, server 1804 generates a notification that the annotated media was received.

At step 1840, the notification that the annotated media was received is sent from server 1804 to employee device 1806 and received by employee device 1806. Employee device 1806 displays the notification to alert the employee that annotated media has been associated with the work order that the employee closed out.

At step 1842, employee device 1806 sends a request for the annotated media to server 1804 and the request is received by server 1804.

At step 1844, in response to the request from employee device 1806 for the annotated media, server 1804 sends the annotated media to employee device 1806 and the annotated media is received by employee device 1806.

At step 1846, employee device displays the annotated media to the employee. When viewing the annotated media, the employee may skip ahead past portions of the annotated media where there are no annotations.

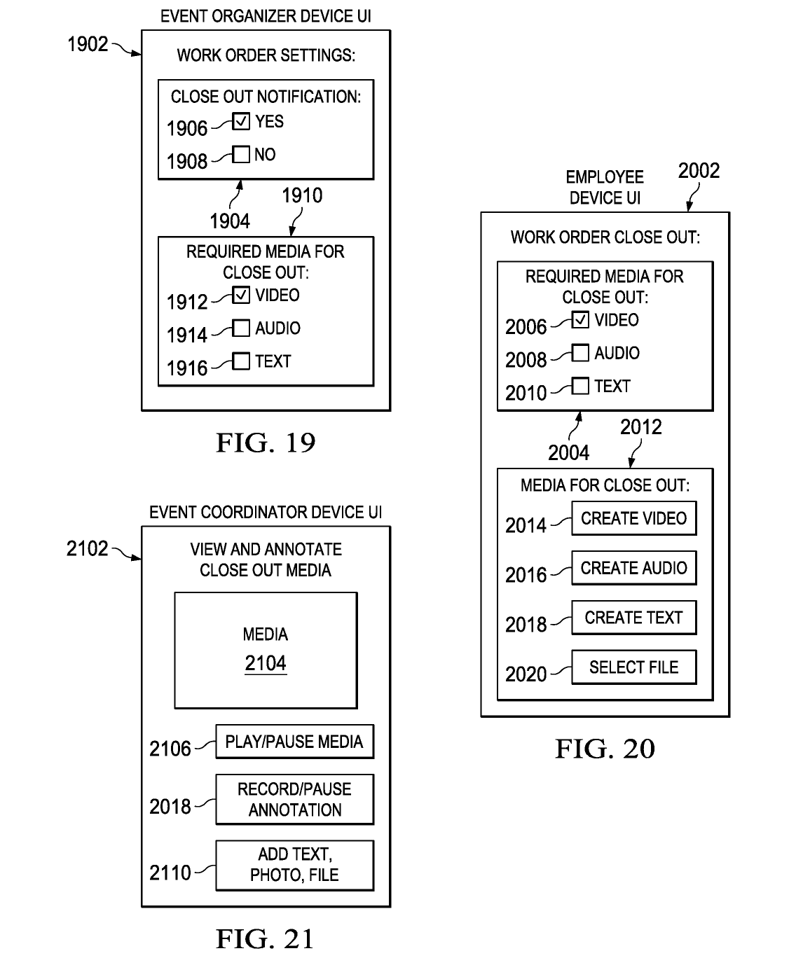

FIG. 19 is an illustration of a user interface displayed on a device of an event organizer that is used to select settings for a work order for an event. User interface 1902 is an embodiment of a user interface displayed on devices 210 and 212 of event organizer 208 of FIG. 2. User interface 1902 displays several settings related to closing out a work order for an event, including close out notification settings 1904 and media requirement settings 1910.

Close out notification settings 1904 include yes checkbox 1906 and no checkbox 1908 that are mutually exclusive. Selecting yes checkbox 1906 requires the server to generate and send a notification to the event organizer device when the work order for the event is closed out. When no checkbox 1908 is selected, the server will not generate and will not send a notification to the event organizer device when the work order is closed out.

Media requirement settings 1910 include video checkbox 1912, audio checkbox 1914, and text checkbox 1916. One of more of checkboxes 1912, 1914, and 1916 can be selected using user interface 1902. When more than one of checkboxes 1912, 1914, and 1916 are selected, multiple types of media will be required to close out the work order. Selecting video checkbox 1912 requires that a video be associated with the close out of the work order. Selection of audio checkbox 1914 requires an audio recording be associated with the close out of the work order. When text checkbox 1916 is selected, a text message is required to be associated with the close out of the work order.

FIG. 20 is an illustration of a user interface displayed on a device of an employee of a supplier that is used to associate media with a close out of a work order for an event. User interface 2002 is an embodiment of a user interface displayed on devices 222 and 224 of first supplier 214 of FIG. 2. After selecting to close out a work order for an event, user interface 2002 is displayed on the employee device. User interface 2002 includes required media settings 2004 and media selection options 2012.

Media settings 2004 are retrieved from a server, such as cloud event server 204 and displayed on user interface 2002. Media settings 2004 include check boxes 2006, 2008, and 2010 that indicate which type of media is required to be associated with the close out for the work order for the event. Video check box 2006 is checked to indicate that a video needs to be included in order to close out the work order. In a preferred embodiment, user interface 2002 does not allow changes to the type of required media that was selected by the event organizer using user interface 1902.

Media selection options 2012 allow the employee to associate one or more types of media with the close out. Selection of create video button 2014 allows the employee to create a video of the work that has been completed on the work order. When create audio button 2016 is selected, the employee can record an audio file that is associated with the close out. Selecting create text button 2018 allows a text message to be created and attached to the close out. Selection of select file button 2020 allows the employee to find a media file on the device that will be associated with the close out.

FIG. 21 is an illustration of a user interface displayed on a device of an event coordinator that is used to create annotated media. User interface 2102 is an embodiment of a user interface displayed on devices 210 and 212 of event organizer 208 of FIG. 2. User interface 2102 allows for the display of a video and to annotate that video. User interface 2012 includes video display window 2104 and buttons 2106, 2108, and 2110.

Media display window 2104 displays, for example, a video that is being annotated. Selecting button 2106 plays or pauses the video displayed in media display window 2104. Selection of button 2108 starts and pauses the recording of audio annotations. When button 2110 is selected, additional media can be selected and added to an annotation. For example, a user presses button 2106 to begin playing a video in media display window 2104. When the video reaches 23 seconds, the user notices something that is not correct and presses button 2106 to pause the video, presses button 2108 to record an annotation with the paused video, presses button 2110 to include a photo of what the incorrect item should look like, and presses button 2106 to resume playing the video. When the video reaches 43 seconds, the user notices something that exceeds expectations and presses button 2108 to start recording an annotation while the video is still playing and then presses button 2108 again to pause recording of the annotation while the video is still playing.

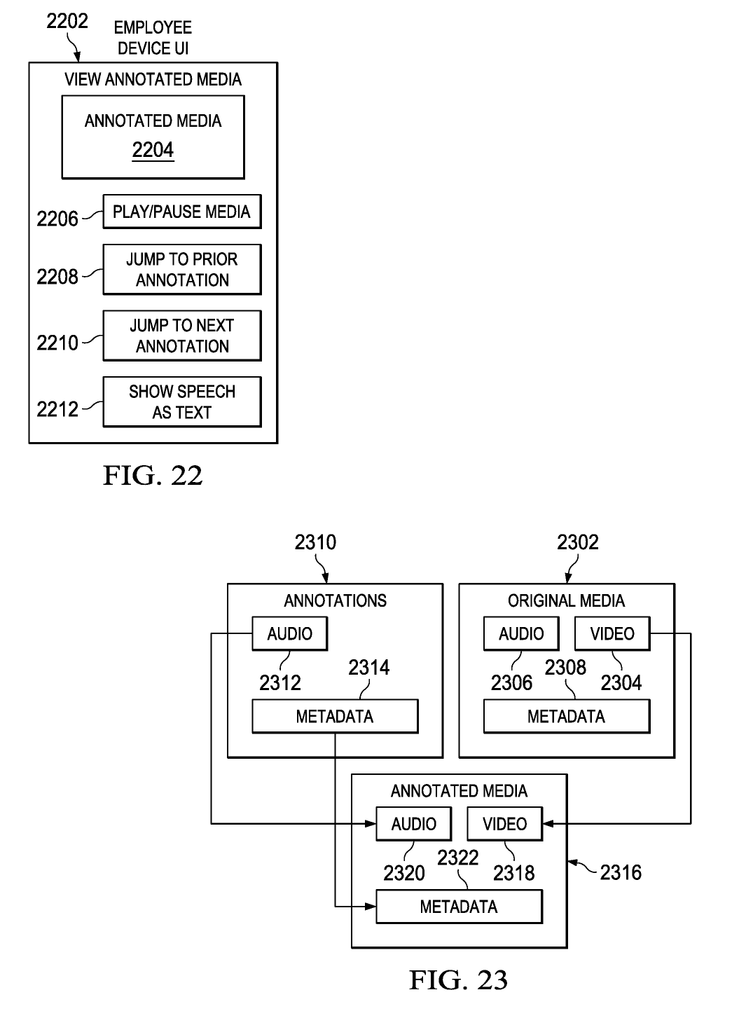

FIG. 22 is an illustration of a user interface displayed on an employee device that is used to view annotated media. User interface 2202 is an embodiment of a user interface displayed on devices 222 and 224 of first supplier 214 of FIG. 2. User interface 2202 allows for the playing of annotated media and for the quickly skipping back and forth to the annotated portions of the annotated media. User interface 2202 includes Annotated media display window 2204 and buttons 2206, 2208, 2210, and 2212.

Annotated media display window 2104 displays the annotated video, the display of which is controlled by buttons 2206, 2208, 2210, and 2212. When selected, button 2206 starts and pauses playback of the annotated media. Selection of button 2208 jumps the playback of the annotated media to the location of a prior annotation. Selecting button 2210 skips the playback forward to a next annotation of the annotated media. When button 2212, is selected, the display of speech of an annotation as text in media display window 2104 is toggled.

FIG. 23 is a diagram of the formation of annotated media in accordance with one preferred embodiment. Original media 2302 is combined with annotations 2310 to form annotated media 2316. Each of original media 2302, annotations 2310 and annotated media 2316 are digital container files that contain sets of data and metadata that can include images, audio, video, text, and the like. Each file is formatted in accordance with a multimedia container format, such as 3GPP, 3GPP2, ISO Base Media, Matroska, MPEG-4 Part 14, QuickTime, and the like.

Original media 2302 is a video recorded with employee device 1806 and includes video 2304, audio 2306, and metadata 2308. For example, Original media 2302 may show a banquet room after having been set up in accordance with a work order and is attached to a close out for that work order.

Annotations 2310 is an audio file recorded with event organizer device 1802 and includes audio 2312 and metadata 2314. Annotations 2310 include the event organizer's spoken comments (annotations) that are recorded in response to the display of original media 2302 on event organizer device 1802. Annotations 2310 also include metadata 2314 that indicates the start time for each comment and whether playback of original media 2302 was paused while recording a comment. Metadata 2314 contains synchronization data that allows the comments recorded in audio 2312 to be synchronized with video 2304 of original media 2302. Metadata 2314 optionally includes additional text notes that are also timed or synchronized to video 2304 of original media 2302 and optionally includes text that is a speech to text conversion of audio 2312 that is similarly timed or synchronized with video 2304 of original media 2302.

Annotated media 2316 is created from annotations 2310 and original media 2302. Annotated media 2316 includes video 2318, audio 2320, and metadata 2322. To create annotated media, original media 2302 and annotations 2310 are decoded and decompressed to be manipulated and mixed and then compressed and encoded to form annotated media 2316. In a preferred embodiment, annotated media 2316 is created on a device, such as event organizer device 1802 of FIG. 18. In one alternative embodiment, a device, such as event organizer device 1802 of FIG. 18, sends annotations 2310 to a server, such as server 1804 of FIG. 18, and the server creates annotated media 2316 from original media 2302 and annotations 2310.

Video 2318 of annotated media 2316 is derived from video 2304 of original media 2302. When annotations 2310 are recorded without pausing original media 2302, video 2318 is a copy of video 2304. When annotations 2310 are recorded with one or more pauses to original medial 2302, video 2318 is created from video 2304 by adding “freeze frames” to video 2304 while video 2304 is paused to create audio 2312 of annotations 2310.

In one embodiment, Audio 2320 of annotated media 2316 is derived from audio 2312 of annotations 2310. Audio 2306 of original media 2302 is discarded when only audio 2312 from annotations 2310 is selected to be used to create audio 2320 of annotated media 2316. Additionally or alternatively, one or more parts of audio 2306 of original media 2302 are used with audio 2312 of annotations 2310 to create audio 2320 of annotated media 2316.

Metadata 2322 of annotated media 2316 is derived from metadata 2314 of annotations 2310. Metadata 2314 includes the start point of any comments recorded in audio 2312 with respect to the timing of video 2304 of original media 2302. The length and timing of video 2318 may differ from that of video 2304. Metadata 2314 of annotations 2310 is updated with these timing differences to form metadata 2322 of annotated media to account for the timing differences between the timing of video 2318 of annotated media 2316 and the timing of video 2304 of original media 2302. In additional or alternative embodiments, metadata 2308 includes text message subtitles that are included in metadata 2322 and synchronized with video 2318.

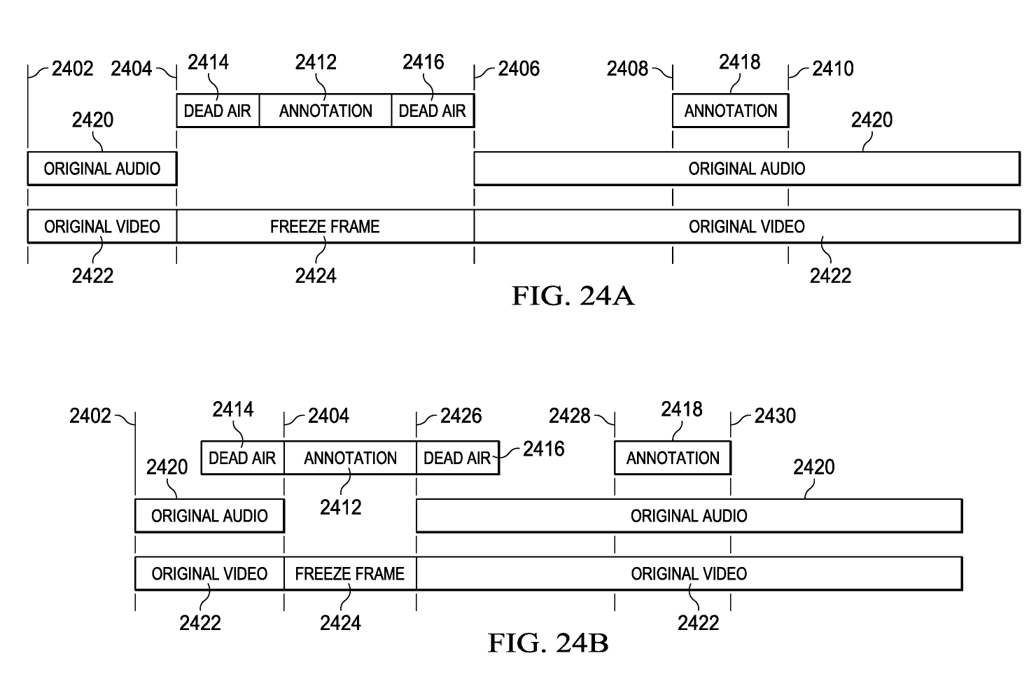

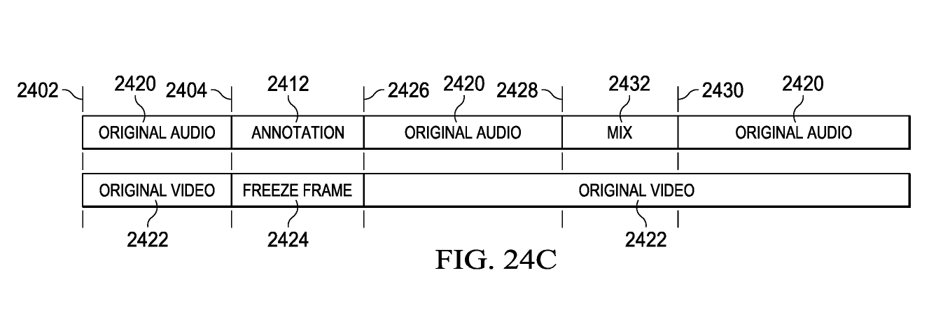

FIGS. 24A, 24B, and 24C are media timing diagrams that illustrate the insertion and mixing of annotations into original media to create annotated media. FIG. 24A shows the timing for two annotations 2412 and 2418 with respect to original media comprising original video 2422 and original audio 2420. Times 2402, 2404, 2406 2408, and 2410 are timings recorded in metadata of the annotations, such as metadata 2314 of annotations 2310 of FIG. 23.

Time 2402 represents the start time of the original media. Time 2404 represents a start time related to first annotation 2412 and time 2406 represents a stop time related to first annotation 2412. First annotation 2412 is surrounded by dead air 2414 and 2416. In response to the original media being paused and a record annotation button being selected, first dead air 2414, first annotation 2412, and second dead air 2416 are recorded in sequence. First dead air 2416 is the time from when the record annotation button is selected until the user actually speaks and first annotation 2412 is recorded. Second dead air 2416 is the time from when the user stops speaking and the pause annotation button is selected. First dead air 2414 and second dead air 2416 may be inadvertently long and unduly extend the length of annotated media created from original media and annotations. Annotation 2412 may additionally include additional dead air within annotation 2412 that can be removed.

With the original media being paused during the first annotation, there is no original audio between time 2404 and time 2406. Freeze frame 2424 is a freeze frame of the last frame of original video 2422 at time 2404 and is inserted into original video 2422 to fill in the time between time 2404 and time 2406.

Time 2408 represents the start time of second annotation 2418 and time 2410 represents the stop time of second annotation 2418. Second annotation 2418 is recorded in response to the record annotation button being selected at time 2408 while playback of the original media continues. The recording of second annotation 2418 continues until a pause annotation button is selected at time 2410.

FIG. 24B is a timing diagram that is condensed after removing dead air 2414 and 2416. Times 2426, 2428, and 2430 are similar to times 2406, 2408, and 2410 and have the same relative spacing as times 2406, 2408, and 2410. Times 2426, 2428, and 2430 are closer to each of times 2402 and 2404, as compared to times 2406, 2408, and 2410, because of the removal of dead air 2414 and 2416. The overall length of annotated media created from the original media and the annotations is shorter with the removal of dead air 2414 and 2416.

FIG. 24C shows the timing diagram for annotated media created from the original media and annotations 2412 and 2418. Annotation 2412 is inserted between portions of original audio 2420 between times 2404 and 2406. Annotation 2418 is mixed with the portion of original audio between times 2408 and 2410 to form mix 2430. Freeze frame 2424 is inserted between portions of original video 2422 between times 2404 and 2406. Times 2402, 2404, 2426 2428, and 2430 are timings recorded in metadata of the annotated media, such as metadata 2322 of annotated media 2316 of FIG. 23.

It will be appreciated by those skilled in the art that the described embodiments disclose significantly more than an abstract idea including technical advancements in the field of data processing and a transformation of data which is directly related to real world objects and situations in that the disclosed embodiments enable a computer to operate more efficiently. For example, the disclosed embodiments transform positions, orientations, and orders related to an event into a graphical representations, images, and electronic messages that can then be used to control the positions, orientations, and orders.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. An apparatus for providing a cloud event planning software service, the apparatus comprising:
a memory; and,
one or more processors programmed to perform the steps of:
receiving media from a second device after the second device closes out a work order related to an event and creates the media;
sending the media to a first device in response to receiving a request for the media from the first device;
receiving annotated media that is created by the first device and is based on the media sent to the first device; and,
sending the annotated media to the second device in response to a request for the annotated media from the second device.

2. The apparatus of claim 1, wherein the one or more processors are further programmed to perform the step of:
receiving one or more event settings in a message from the first device, the event settings related to the event.

3. The apparatus of claim 2, wherein the one or more processors are further programmed to perform the step of:
saving the event settings received from the first device to a non-transitory computer readable medium.

4. The apparatus of claim 3, wherein the one or more processors are further programmed to perform the step of:
sending the event settings to the second device after the second device displays an event work order related to the event and the event settings.

5. The apparatus of claim 4, wherein the one or more processors are further programmed to perform the step of:
generating a notification of a close out performed by the second device.

6. The apparatus of claim 5, wherein the one or more processors are further programmed to perform the step of:
sending the notification of the close out performed by the second device to the first device.

7. The apparatus of claim 6, wherein the one or more processors are further programmed to perform the step of:
after sending the notification of the close out performed by the second device, receiving a request from the first device for a media associated with the close out performed by the second device.

8. The apparatus of claim 7, wherein the one or more processors are further programmed to perform the step of:
generating a notification that the annotated media related to the work order and the event has been received.

9. The apparatus of claim 8, wherein the one or more processors are further programmed to perform the step of:
sending the notification that the annotated media has been received to the second device.

10. The apparatus of claim 9, wherein the one or more processors are further programmed to perform the step of:
after sending the notification that the annotated media had been received, receiving the request for the annotated media from the second device.

11. A method for providing a cloud event planning software service, the method comprising:
receiving media from a second device after the second device closes out a work order related to an event and creates the media;
sending the media to a first device in response to receiving a request for the media from the first device;
receiving annotated media that is created by the first device and is based on the media sent to the first device; and,
sending the annotated media to the second device in response to a request for the annotated media from the second device.

12. The method of claim 11, further comprising:
receiving one or more event settings in a message from the first device, the event settings related to the event.

13. The method of claim 12, further comprising:
saving the event settings received from the first device to a non-transitory computer readable medium.

14. The method of claim 13, further comprising:
sending the event settings to the second device after the second device displays an event work order related to the event and the event settings.

15. The method of claim 14, further comprising:
generating a notification of a close out performed by the second device.

16. The method of claim 15, further comprising:
sending the notification of the close out performed by the second device to the first device.

17. The method of claim 16, further comprising:
after sending the notification of the close out performed by the second device, receiving a request from the first device for a media associated with the close out performed by the second device.

18. The method of claim 17, further comprising:
generating a notification that the annotated media related to the work order and the event has been received.

19. The method of claim 18, further comprising:
sending the notification that the annotated media has been received to the second device.

20. The method of claim 19, further comprising:
after sending the notification that the annotated media had been received, receiving the request for the annotated media from the second device.
